(19) United States
(12) Patent Application Publication
(10) Pub. No.: US 2009/0042148 A1
(43) Pub. Date: Feb. 12, 2009

(54) Photoresist Composition for Deep UV and Process Thereof

(76) Inventors: Munirathna Padmanaban, Bridgewater, NJ (US); Srinivasan Chakrapani, Bridgewater, NJ (US); Guanyang Lin, Whitehouse Station, NJ (US)

Correspondence Address: SANGYA JAIN;AZ ELECTRONIC MATERIALS USA CORP., 70 MEISTER AVENUE, SOMERVILLE, NJ, 08876, US

(21) Appl. No.: 11/834,490

(22) Filed: Aug. 6, 2007

(51) Int. Cl. G03C 1/04; G03C 5/00

(52) U.S. Cl. 430/327; 430/270.1; 430/286.1

(57) ABSTRACT

The present invention refers to a photoresist composition comprising (i) a polymer A comprising at least one acid labile group; (ii) at least one photoacid generator; (iii) at least one base; (iv) a polymer B, where polymer B is non-miscible with polymer A and soluble in the coating solvent, and; (v) a coating solvent composition. The present invention also relates to the process of imaging the photoresist.

### FIELD OF INVENTION

The present invention relates to a novel photoresist composition comprising a novel polymer mixture which is sensitive to radiation in the deep ultraviolet, particularly a positive working photoresist sensitive in the range of 100-300 nanometers (nm). The present invention also relates to a process for imaging the photoresist composition of this invention.

### BACJGROUND OF INVENTION

Photoresist compositions are used in microlithography processes for making miniaturized electronic components such as in the fabrication of computer chips and integrated circuits. Generally, in these processes. a thin coating of film of a photoresist composition is first applied to a substrate material, such as silicon wafers used for making integrated circuits. The coated substrate is then baked to evaporate any solvent in the photoresist composition and to fix the coating onto the substrate. The photoresist coated on the substrate is next subjected to an image-wise exposure to radiation.

The radiation exposure causes a chemical transformation in the exposed areas of the coated surface. Visible light, ultraviolet (UV) light, electron beam and X-ray radiant energy are radiation types commonly used today in microlithographic processes. After this image-wise exposure, the coated substrate is treated with a developer solution to dissolve and remove either the radiation exposed or the unexposed areas of the photoresist.

The trend towards the miniaturization of semiconductor devices has led to the use of new photoresists that are sensitive to lower and lower wavelengths of radiation and has also led to the use of sophisticated multilevel systems to overcome difficulties associated with such miniaturization. There are two types of photoresist compositions, negative-working and positive-working. When negative-working photoresist compositions are exposed image-wise to radiation, the areas of the resist composition exposed to the radiation become less soluble to a developer solution (e.g. a cross-linking reaction occurs) while the unexposed areas of the photoresist coating remain relatively soluble to such a solution. Thus, treatment of an exposed negative-working resist with a developer causes removal of the non-exposed areas of the photoresist coating and the creation of a negative image in the coating, thereby uncovering a desired portion of the underlying substrate surface on which the photoresist composition was deposited.

On the other hand, when positive-working photoresist compositions are exposed image-wise to radiation, those areas of the photoresist composition exposed to the radiation become more soluble to the developer solution while those areas not exposed remain relatively insoluble to the developer solution. Thus, treatment of an exposed positive-working photoresist with the developer causes removal of the exposed areas of the coating and the creation of a positive image in the photoresist coating. Again, a desired portion of the underlying surface is uncovered.

Photoresist resolution is defined as the smallest feature which the photoresist composition can transfer from the photomask to the substrate with a high degree of image edge acuity after exposure and development. In many manufacturing applications today, photoresist resolution on the order of less than one micron are necessary. In addition, it is almost always desirable that the developed photoresist wall profiles be near vertical relative to the substrate. Such demarcations between developed and undeveloped areas of the resist coating translate into accurate pattern transfer of the mask image onto the substrate. This becomes even more critical as the push toward miniaturization reduces the critical dimensions on the devices.

Photoresists sensitive to short wavelengths, between about 100 nm and about 300 nm can also be used where subhalfmicron geometries are required. Particularly preferred are photoresists comprising non-aromatic polymers, a photoacid generator, a base, and solvent.

High resolution, chemically amplified, deep ultraviolet (100-300 nm) positive and negative tone photoresists are available for patterning images with less than quarter micron geometries. Chemically amplified resists, in which a single photo generated proton catalytically cleaves several acid labile groups, are used in photolithography applicable to sub quarter-micron, design rules. To date, there are three major deep ultraviolet (uv) exposure technologies that have provided significant advancement in miniaturization, and these are lasers that emit radiation at 248 nm, 193 nm and 157 nm. Examples of such photoresists are given in the following patents and incorporated herein by reference, U.S. Pat. No. 4,491,628, U.S. Pat. No. 5,350,660, and U.S. Pat. No. 5,843,624. Photoresists for 248 nm have typically been based on substituted polyhydroxystyrene and its copolymers. On the other hand, photoresists for 193 nm exposure require non-aromatic polymers, since aromatics are opaque at this wavelength. Generally, alicydlic hydrocarbons are incorporated into the polymer to replace the etch resistance lost by the absence of aromatics.

Photoresists based on chemical amplification mechanism are employed for 248 and 193 nm applications. However, the photoresist materials applicable for 248 nm cannot be used at 193 nm due to the high absorption of the poly(4-hydroxystyrene) based polymers used for 248 nm applications. 193 nm applications typically require non-aromatic compounds. Open-chain aliphatic resins cannot be used: due to the very high etch rates of these materials. Polymers possessing annelated structures in the side chains such as tricycliododecyi and adamantane or cycloolefins in the main chain are shown to provide etch required etch resistance.

In order to further improve the resolution and depth of focus of photoresists, immersion lithography is a technique that has recently been used to extend the resolution limits of deep uv lithography imaging. In the traditional process of dry lithography imaging, air or some other low refractive index gas, lies between the lens and the wafer plane. In immersion lithography a fluid is present between the objective lens and the wafer to enable higher orders of light to participate in image formation at the wafer plane. in this manner the effective numerical aperture of the optical lens (NA) can be increased to greater than 1, where NA_{wet}=nᵢsinθ, where NA_{wet} is the numerical aperture with immersion lithography, n, is refractive index of liquid of immersion and sinθ is the angular aperture of the lens. Increasing the refractive index of the medium between the lens and the photoresist allows for greater resolution power and depth of focus. This in turn gives rise to greater process latitudes in the manufacturing of IC devices. The process of immersion lithography is described in ‘Immersion liquids for lithography in deep ultraviolet’ Switkes et al. Vol. 5040, pages 690-6199, Proceedings of SPIE.

For 193 nm and 248 nm and higher wavelengths immersion lithography, water is of sufficient inherent transparency so that it can be used as the immersion fluid. Alternatively, if a higher NA is desired, water's refractive index can be increased by doping with UV transparent solutes.

One important concern in immersion lithography is the extraction of components from the photoresist film into the immersion fluid. These components may either be ones present in the film prior to exposure (e.g. base additives, photoacid generators. solvent, dissolution inhibitors, plasticizers, leveling agents,) or present in the film during or shortly after exposures (e.g. photoacid, photoacid generator, photo fragments, scission fragments from the polymer or the other additives, salt of the photoacid and base additive.) The extraction of these materials is of concern for two reasons. firstly, it may affect photoresist performance deleteriously, and the second is the deposition of UV absorbing films on the objective lens in contact with the immersion fluid due to the photoreaction of extracted components in the immersion fluid.

There is also a need to have a photoresist with a high water contact angle to reduce immersion related defects, such as the “water mark” which may be formed by the immersion liquid between the lens and the photoresist. High water contact angle is also desirable for high throughput through the immersion exposure equipment. There is a further need to have low water contact angle and low developer contact angle in the exposed regions after post exposure bake and prior to the development step to reduce any bubble effects.

Thus there is a need for a photoresist that can prevent the extraction of undesirable materials from the photoresist, reduce defects and increase throughput. One method is to provide for a barrier layer that is coated over the photoresist film. However, the barrier coat requires an additional material and an additional coating step, which can incur further cost to the manufactures of the device. Thus, a photoresist that could itself form an in-situ barrier coat would be preferred. The present invention relates to a novel photoresist that is capable of forming an in-situ barrier coat upon heating the photoresist film and the photoresist composition comprises at least 2 polymers, where at least one is non-miscible, such that the non-miscible polymer forms an in-situ surface layer in the photoresist. The in-situ surface layer prevents leaching of materials from the bulk of the photoresist, and can become soluble, in the developer. The novel photoresist provides good lithographic properties and has good storage stability.

### SUMMARY OF THE INVENTION

The present invention refers to a: photoresist composition comprising (i) a polymer A comprising at least one acid labile group; (ii) at least one photoacid generator; (iii) at least one base; (iv) a polymer B, where polymer B is non-miscible with polymer A and soluble in the coating solvent, and; (v) a coating solvent composition.

The present invention also refers to the novel composition where polymer B comprises a unit of structure 1,

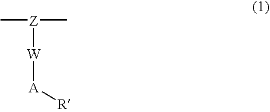

where Z is the polymer backbone, W is a single bond or a spacer group, A is an acid group without a proton and R′ is hydrogen or an acid labile group.

The novel composition also refers to the novel: composition where polymer B comprises a unit of structure 2,

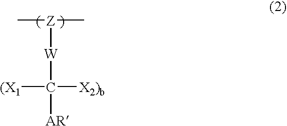

where Z is the polymer backbone, W is a single bond or a spacer group, X₁ and X₂ are partially or fully fluorinated (C₁-C₆) alkyl groups, b=1-6, A is an acidic group without a proton, and R′ is selected independently from hydrogen and an acid labile group.

The invention also refers to a process of imaging the above compositions.

### BRIEF DESCRIPTION OF THE DRAWINGS

FIG. 1 refers to examples of monomers

FIG. 2 refers to further Examples of monomers

FIG. 3 refers to examples of monomers with R₃ group

FIG. 4 refers to examples of monomers with R₄ group

FIG. 5 examples of monomers with R₅ group

FIG. 6 Examples of suitable ammonium bases.

### DETAILED DESCRIPTION OF THE INVENTION

The present invention relates to a novel photoresist composition comprising (1) a polymer A comprising at least one acid labile group, (ii) at least one photoacid generator, (iii) at least one base, (iv) a polymer B, where polymer B is non-miscible with polymer A and also soluble in the coating solvent, and, (v) a coating solvent composition. The present invention also relates to a process for imaging the novel composition, especially in immersion lithography.

The present novel composition comprises a blend of at least two polymers A and B, where all the polymers are soluble in the coating solvent but at least one polymer (B) is non-miscible with the other polymer(s) B. A non-miscible polymer is one which under certain conditions will separate in the coated film. Polymer A is a polymer typically used in dry lithography and comprises at least one acid labile group. In the present invention non-miscible refers to the separation of the non-miscible polymer in the photoresist film during the coating and/or baking step of the photoresist, such that some of or the entire non-miscible polymer B essentially migrates towards the surface of the photoresist film. The surface migration of the polymer provides the photoresist with an in-situ barrier or protective coat which can prevent leaching of undesirable materials from the photoresist and provide an in-situ top coat within the coated photoresist layer with desirable properties. Polymer B comprises at least one group which makes the polymer nonmiscible with Polymer A and such a group may be a fluorinated acidic group or fluorinated acidic group capped with an acid labile group. The fluorinated acidic group may be fluorinated alcohol, fluorinated thiol, fluorinated carboxylic acid, fluorinated sulfonic acid, fluorinated sulfonamide, etc. In one embodiment of Polymer B, the non-miscible polymer B may comprise an acid labile group, where the acid labile group prior to exposure of the photoresist provides the photoresist surface with a high water contact angle, but after post exposure bake the acid labile group is completely or partially removed to form a hydrophilic polymeric surface which has in the exposed regions, a lower developer contact angle than prior to exposure. The lower developer contact angle assists in providing good development profiles of the imaged photoresist, especially free of scum residues.

In one embodiment of Polymer B, which is soluble in the coating solvent, Polymer B comprises an acid labile group. In another embodiment of Polymer B the polymer comprises an acid labile group and a halogenated acidic group. In yet another embodiment of Polymer B, the polymer comprises no acid labile group but comprises a halogenated acidic group, such as a fluoroalcohol group. Where the polymer B comprises an acidic group, the polymer is essentially insoluble in an aqueous alkali solution prior to exposure but becomes aqueous alkali soluble prior to development. The polymer B may be a homopolymer or polymer comprising more than one monomeric unit. Polymer B can comprise an acid labile group which may be obtained by reacting an acidic group in the polymer with a compound capable of forming an acid labile group, The acidic group on the polymer may be selected from fluoroalcohol, fluorothiol, carboxylic acid, sulfonic acid and sulfonamide. The acidic proton of the acidic group reacts with compounds such as chloromethylmethylether and tertiarybutyl bromoacetate to form an acid labile group capable of deprotecting in the presence of a strong acid. The polymer may be fully protected or partially protected. The polymer may be poly(meth)acrylate, polyvinylether, polyalkylene, polyfluorinatedalkylene, or a copolymer of poly(alkylene-co-(meth)acrylate) or poly(fluorinatedalkylene-co-(meth)acrylate), etc. The polymer B may comprise halogen (F, Br, I) or silicon to provide the appropriate nonmiscibility properties, and preferably fluorine Polymer B may be represented by the structure 1,

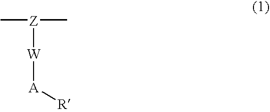

where Z is the polymer backbone, W is a single bond or a spacer group, A is an acid group without a proton and A can be selected from oxygen (O), sulfur (S), carboxyl (C(O)O), sulfonyl (SO₃) and sulfonamidyl (SO₂NH), and R′ is selected independently from hydrogen and an acid labile group. The functionality (-AH) is capable of reacting with a compound to form the acid labile group (R′), which can deprotect in the presence of a strong acid to form the polymer comprising the group -AH. In one example the unit of structure 1 is fluorinated. In another example the unit of structure 1 is not fluorinated and the polymer further comprises monomeric units with fluorinated acidic groups, i.e. R′ is an acid labile group. In yet another example the polymer, R′ is hydrogen and no acid labile groups are present, specifically W is fluorinated,

Polymer B may be represented by structure 2,

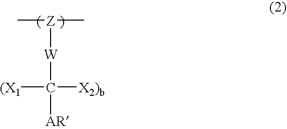

where Z is the polymer backbone, W is a single bond or a spacer group, X₁ and X₂ are partially or fully fluorinated (C₁-C₆) alkyl groups, b=1-6, A is an acidic group without a proton, and A is selected from oxygen (O), sulfur (S), carboxyl (COO), sulfonyl (SO₃) and sulfonamidyl (SO₂NH), and R′ is selected independently from hydrogen and an acid labile group. W, A and R′ are described herein.

In structure 1 and 2, Z is the polymeric backbone, such as alkylene which is unfluorinated or fully or partially fluorinated alkylene, etc. The alkylene, unfluorinated or fully or partially fluorinated alkylene, may be linear, branched, cyclic or mixture of these, Z may be a partially fluorinated cycloalkylene group or comprise a mixture of monomeric units which are partially fluorinated cycloalkylene group and fluorinated alkylene group. The cycloalkylene group may be 5 or 6 membered ring moiety. Specific examples of Z are shown in structure 3 and 4 a, b, c, d and e, and mixtures of these may be used, structures 4b-4e may be further fluorinated:

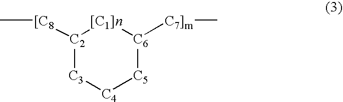

where ‘n’ can be zero to 3 and C₁ to C₈ can be attached to hydrogen or fluorine independent of one another.

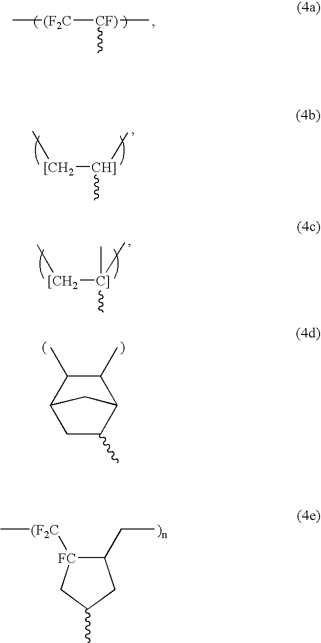

In the polymer B, as shown in the previous structures 1 and 2, W is a single valence bond connecting the pendant moiety to the backbone or W may be a connecting or spacer group connecting the pendant moiety, A, to the backbone. Preferably W is nonaromatic group. Examples of W as a spacer group can be an organic group, and examples of an organic group are an aliphatic cyclic alkylene group, aliphatic linear or branched alkylene group, fully or partially fluorinated aliphatic cyclic alkylene group, fully or partially fluorinated aliphatic linear or branched alkylene group, carbonyl (CO)f, carbonyloxy or carboxyl (C(O)—O), oxycarbonyl (O—C(O)), carbonate (O—C(O)'O), sulfone (SO₂), sulfoxide (SO), oxy (O), sulfide (S), aliphatic cyclic alkylene group with a pendant group selerted from carbonyl (CO), carbonyloxy (C(O)—O), oxycarbonyl (O—C(O)), carbonate (O—C(O)—O), sulfone (SO₂), sulfoxide (SO), oxy (O), sulfide (S); and mixtures of these groups. Preferably, W in structures 1 and 2 may be O, (C(O)—O), O—fluoroalkylene-C(O)—O, alkylene, fully or partially fluorinated alkylene, and fully or partially fluorinated alkylene oxy or mixtures of these. Preferably, W in structure 2 may be a single bond, O, (C(O)—O), X₁ and X₂ are independently an (C₁-C₆) alkyl group which maybe fully or partially substituted with fluorine. Examples of X₁ and X₂ may be CF₃, CHF₂, CFH₂, where b is 1-4. R′ is hydrogen or an acid labile group which in the presence of a strong acid is removed and is described herein.

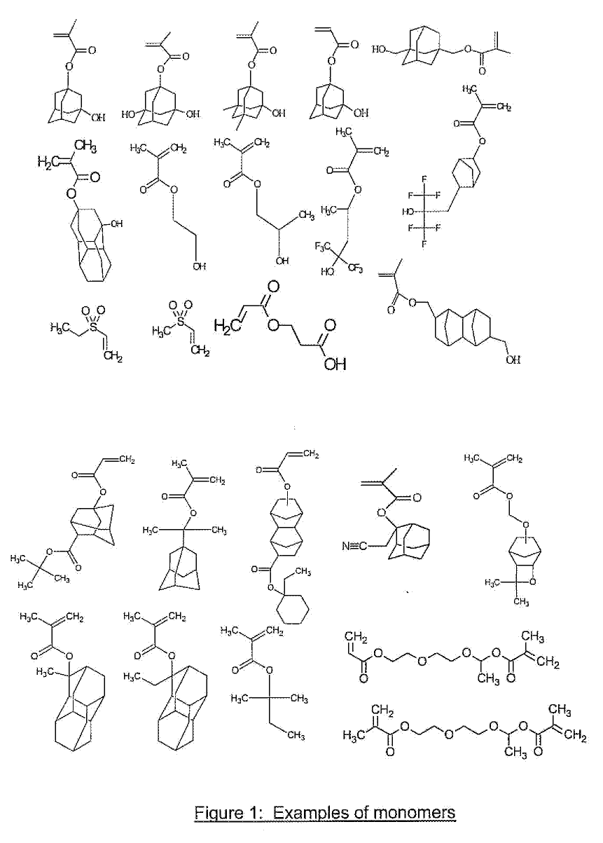

The polymer B may be a homopolymer of structure 1 or 2, or a copolymer comprising a monomeric unit of structure 1 or 2 and at least one other monomeric unit. Examples of comonomers useful for obtaining Polymer B are given in FIGS. 1 to 5, which may comprise an acid labile group. Further examples of polymer B are shown below.

Polymer B such as those comprising structures 5 and 6 may also be used.

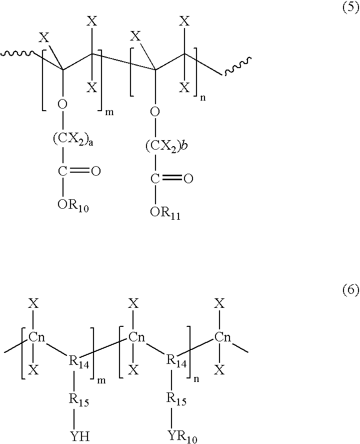

where X is H or halogen (F, Br, I), (CX₂) is fully or partially fluorinated alkyl, a=1-6, b=1-6, m and n are integers, R₁₀ is an acid labile group or hydrogen, R₁₁ is selected independently from hydrogen and an nonlabile group such as alkyl, R₁₄ is substituted or unsubstituted alkylene, Alkylene includes, linear, branched or cyclic group such as cyclo butane, pentane, hexane, norbornene, tricyclododecene. The alkylene may be substituted with groups such as halogen, hydroxyl, carboxylic groups. R₁₄ can be a fluorinated or unsubstituted alkylene. R₁₅ is alkylene or halogen substituted alkylene, YH is hydroxyl, thiol, carboxylic acid, sulfonic acid, sulfonamide, R₁₀ is any group cleavable by acid, and m and n are integers

Further examples of monomeric units of structure 1 or 2 in polymer B, are given in structure 7 and 8,

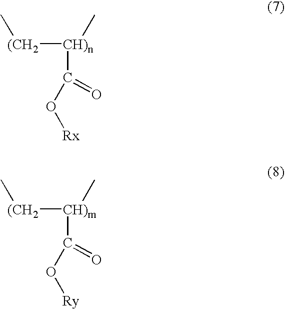

where m and n are integers and Rx and Ry are independently selected from alkyld substituted alkyl, cycloalkyl, and substituted cycloalkyl and comprise at least one hexafluoroalcohol group which is free or protected with an acid labile group. Rx and Ry can be identical or different. Rx can be free of protection; as an example a copolymer of 3,5-Bis(hexafluoro-2hydroxy-2-propyl)cyclohexyl methacrylate and 1-cyclo hexyl-4,4,4-trifluoro-3-hydroxy-3-(trifluromethyl )but-1-yl methacrylate.

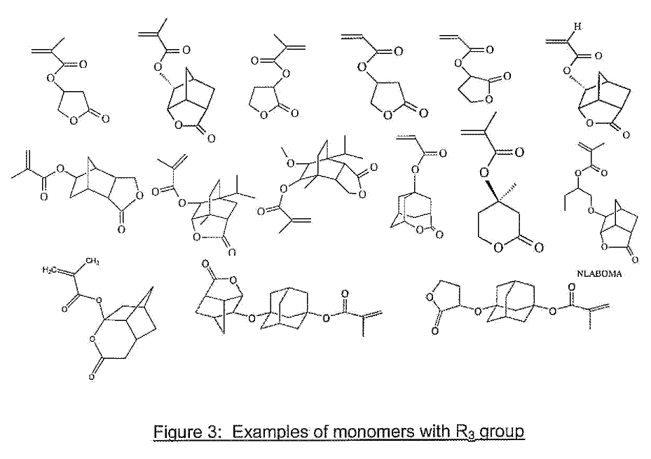

Further examples of polymer B comprise the unit of structure 9,

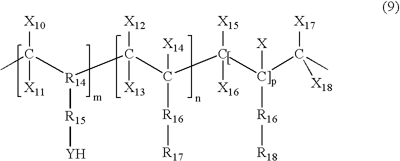

where m, n and p are integers. X₁₀-X₁₈ are independently selected from H, alkyl and halogen (preferably F). R₁₄ is substituted or unsubstituted alkylene. R₁₄ includes cycloalkylene group such as cyclobutane, cyclopentane, cyclohexane, norbornene, and tricyclododecene, which may be unsubstituted or substituted with halogen. The alkylene may be substituted with fluorine. R₁₅ is alkylene or halogen substituted alkylene, R₁₆ is a carboxy group, YH is hydroxy or thiol or carboxylic acid group, R₁₇ is any group cleavable by acid and R₁₈ is any lactone group. Lactone containg monomers are exemplified in FIG. 3.

Another example of polymer B is given in structure 10,

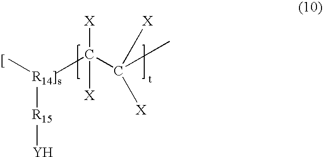

where s and t are integers. X is H or halogen. Preferably halogen is fluorine. R₁₄ is substituted or unsubstituted alkylene, including cycloalkylene groups such as cyclobutane, cyclopentane, cyclohexane, norbomene, and tricyclododecene. The alkylene may be substituted with groups such as halogen, hydroxy, carboxylic groups. R₁₄ can be substituted with fluorine. R₁₅ is alkylene or halogen substituted alkylene. Preferably halogen is fluorine. YH is hydroxy or thiol or carboxylic acid group. Preferably YH is hydroxy. In one example YH is hydroxy and free of capping. The polymer of structure 10 may be further reacted to give a polymer which is fully or partially capped with an acid labile group, i.e. YH is reacted to give an acid labile group.

Polymer B may be as shown in structure 11

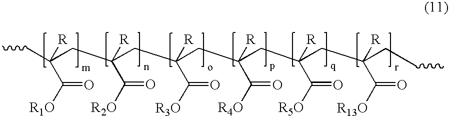

where R, R₁, R₂, R₃, R₄, R₅, m, n, o, p, q are as explained in the general structure for polymer A in structure 14, and R₁₃ is any group that increases the water contact angle compared to the polymer without this group. R₁₃ is for example halogen containing group, such as an acidic fluoroalcohol or fluorocarboxylic acid substituted alkyl groups, where the alkyl groups may be perfluoro adamantyl, perfluoro norbornyl, perfluoro cyclohexyl, perfluoro cyclopentyl perfluoro butyl, perfluoro ethyl etc., r may represent 40-100 mole % of the polymer.

Specific examples of polymer B are given in structures 12 and 13,

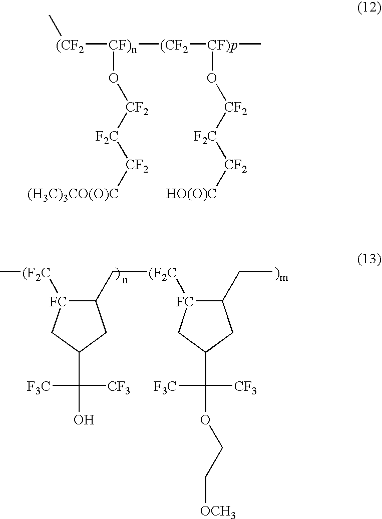

where n, m and p are integers.

Polymer B may be a homopolymer or a copolymer comprising units of structure 1 to 10 and other comonomeric unit(s). Comonomeric units may be such as those in FIGS. 1-5. Copolymer B may contain about 30 mol % to 99 mole % of structure 1-10, and preferably about 40 mol % to about 80 mole %.

In the various embodiments, examples of acid labile groups are acetal protecting groups exemplified by alkyloxyalkyl, such as methyloxymethyl, adamantyl methyloxymethyl, bicyclohexyloxymethyl, ethyloxymethyl, menthyloxymethyl, and cyclopentyloxymethyl; acetal type esters may be used, such as ethoxymethylester, 1-ethoxyethylester, 1-isobutoxyethylester, 1-isopropoxyethylester, 1-ethoxypropylester, 1-(2-methoxyethoxy)ethylester, 1-(2-acetoxyethoxy)ethylester, 1-[2-(1-adamantyloxy)ethoxy]ethylester, 1-[2-(1-adamantancarbonytoxy)etho-xylethylester, tetrahydro-2-furylester and tetrahydro-2-pyra nylester, 2-alkyl-2-adamantyl, 1-adamantyl-1-alkylalkyl and alicyclic ester such as isobornylester, or acid cleaveable alkoxycarbonyl (e.g. tert-butoxycarboxyl, t-BOC), alkyleneoxyalkyl groups, trialkylsilyi, and 2-(trialkylsilyl)ethyl. Acid labile groups may be incorporated into any of the suitable monomeric units of the polymer:.

Polymer B may only comprise one or more types of units of structure 1 to structure 13. Specific examples of Polymer B are poly(1,1,2-Trifluoro-4-[2,2,2-trifluoro-1-hydroxy-1-trifluoromethylethyl]-1,6-heptadiene)(TFTFHTFMH) preferably protected with an acid labile group such as methoxymethyl group at suitable levels; a 50/50 copolymer of 3,5-Bis(hexafluoro-2hydroxy-2-propyl)cyclohexyl methacrylate and 1-cyclohexyl-4,4,4-trifluoro-3-hydroxy-3-(trifluromethyl)but-1-yl methacrylate as represented by structures 7 & 8; and a copolymer of (structure 4) [2-fluoro-2-hexafluoroisopropylhydroxymethyl]-5-norbornene and tetrafluoroethylene.

Polymer B may be made by free radical polymerization of mixtures of suitable monomers using Perkadox-16 free radical initiator in tetrahydrofuran (THF) and recovering the polymer using appropriate non-solvents. The weight average molecular weight may range from about 1000 to about 100, 000, preferably 2000 to about 30,000. Polymer B as the weight % of the photoresist polymer may range from about 0.1 to about 25 weight %, or about 0.1 to about 10 weight %, or 0.1 to about 5 weight %. The polymer B alone or as in the novel photoresist and in-situ separated can have a water contact angle from about 70° to about 95° before exposure in water. preferably from about 75° to about 95°. In one example the water contact angle is from about 80° to about 95°. Similarly, Polymer B can have an aqueous alkali developer contact angle from about 70° to about 90° before exposure, or in the range of about 70° to about 85°. After exposure and baking to remove some or the entire acid labile group in Polymer B. the polymer can have an aqueous alkali developer contact angle of less than 75°, or in the range of about 50° to about 70°. Typically, polymer A has a water contact angle of about 50° to about 75° before exposure. Thus a photoresist comprising a mixture of polymer A and B gives a coating with a higher water contact angle than a coating without polymer B. In addition to the contact angle limitations, the leaching of the components out of the novel photoresist film is less than or equal to 1.6×10⁻¹² mol/cm²/sec.

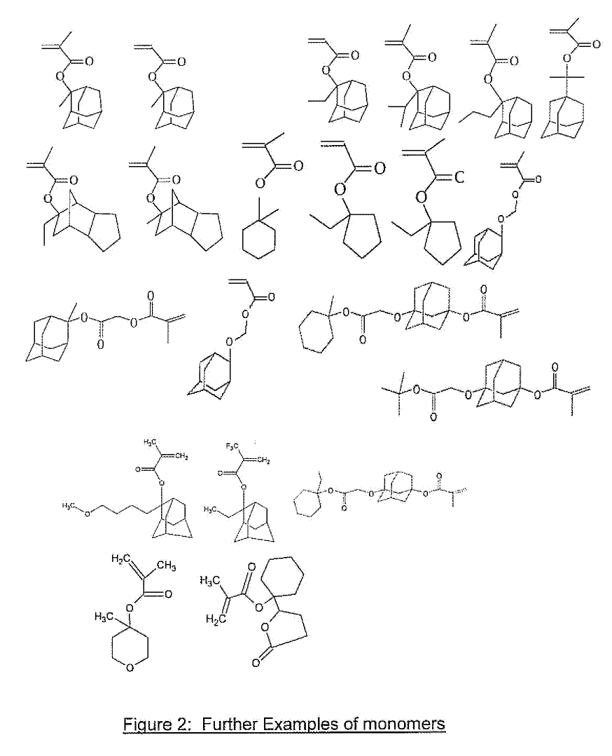

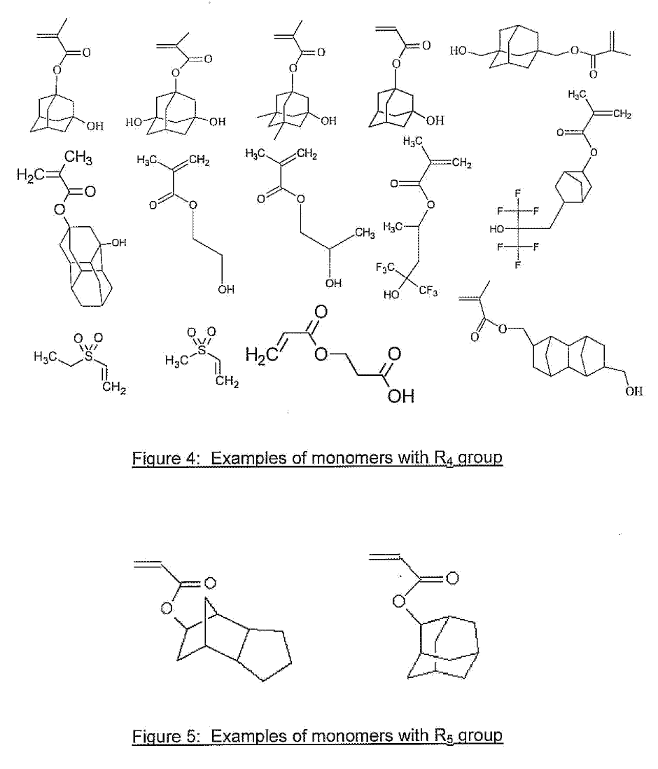

Polymer A comprises at least one acid labile group, which is removed in the presence of a strong acid. Polymer A may be a polymer which is typically used in a photoresist composition for non-immersion lithography, i.e. dry lithography. Such polymers are typically poly(meth)acrylates with no or very small amount (less than 1 mole %) of fluorine or silicon. Polymer A is not miscible with polymer B in the photoresist film coating. Examples of monomers that can be used to form polymer A are given in FIG. 1-5 Polymer A may contain any number of different comonomeric units, and may be 3, 4, 5 or 6 different units. One or more types of acid labile units may be present in the polymer. Examples of acid labile groups have been given previously. An example of suitable Polymer A is given in structure 14, comprising at least 4 different monomeric units (i) to (iv) and optionally (v),

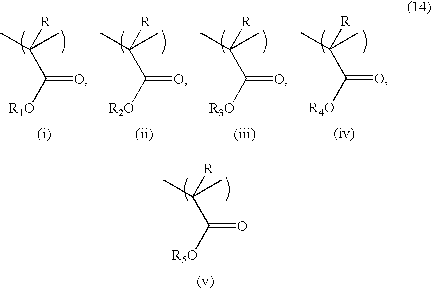

where R is H, substituted alkyl, unsubstituted alkyl; R₁ to R₅ is independently selected from a group comprising an acid labile group, a group comprising substituted or unsubstituted lactone, a group comprising substituted or unsubstituted alkyl group. In one example of Polymer A, R₁ is an acid labile group, R₂ is another acid labile group different from R₁, R₃ is a group comprising a lactone group, R₄ is a substituted or unsubstituted alkyl, and optionally, R₅ is independently selected from an acid labile group, a group comprising a substituted or unsubstituted lactone, and substituted or unsubstituted alkyl groups Examples of monomers used to form the polymer of structure 14 are given in FIG. 1 and 2, FIG. 3 refers to examples of R₃. FIG. 4 refers to examples of R₄. FIG. 4 refers to examples of R₅. In one specific example of Polymer A, the polymer comprises R₁ which is an acid cleavable group and R₂ which is a different acid cleavable group.

Other types of polymers may also be used, such as norbornene based polymers, norbornene and acrylate copolymers, etc. Useful polymers are described in the following US patents and applications, U.S. Pat. No. 6,991,888 and U.S. Pat. No. 7,122,291, and application Ser. No. 11/623335 (of Jan. 16, 2007).

The weight average molecular weight of the Polymer A may range from about 2000 to about 100,000 preferably 3000 to about 30,000. Typically Polymer A has a water contact angle from about 50° to about 75° prior to exposure.

In the above definitions and throughout the present specification, unless otherwise stated the terms used are described below.

Alkyl means linear or branched alkyl having the desirable number of carbon atoms and valence. The alkyl group is generally aliphatic and may be cyclic or acyclic (i.e. noncyclic). Suitable acyclic groups can be methyl, ethyl, n-or iso-propyl, n-,iso, or tert-butyl, linear or branched pentyl, hexyl, heptyl, octyl, decyl, dodecyl, tetradecyl and hexadecyl. Unless otherwise stated, alkyl refers to 1-20 carbon atom moeity. The cyclic alkyl groups may be mono cyclic or polycyclic. Suitable example of mono-cyclic alkyl groups include substituted cyclopentyl, cyclohexyl, and cycloheptyl groups. The substituents may be any of the acyclic alkyl groups described herein. Suitable bicyclic alkyl groups include substituted bicyclo[2.2.1]heptane, bicyclo[2.2.2]octane, bicyclo[3.2.1]octane, bicyclo[3.2.2]nonane, and bicyclo[3.3.2]decane, and the like. Examples of tricyclic alkyl groups include tricyclo[5.4.0.0.^{2,9}]undecane, tricyclo[4.2.1.2.^{7,9}jundecane, tricyclo[5.3.2.0.^{4.}9]dodecane, and tricyclo[5.2.1.0.^{2,6}]decane. As mentioned herein the cyclic alkyl groups may have any of the acyclic alkyl groups as substituents. Examples of multicyclic alkyl groups are adamantyl and norbornyl. Any of the alkyl groups may be substituted with halogen, such as fluorine; hydroxy, carboxylic acid, thiol, fluoroalcohol, etc.

Alkylene groups are divalent alkyl groups derived from any of the alkyl groups mentioned hereinabove. When referring to alkylene groups, these include an alkylene chain substituted with (C₁-C₆)alkyl groups in the main carbon chain of the alkylene group. Alkylene groups can also include one or more alkyne groups in the alkylene moiety, where alkyne refers to a triple bond. Essentially an alkylene is a divalent hydrocarbon group as the backbone. Accordingly, a divalent acyclic group may be methylene, 1,1- or 1,2-ethylene, 1,1-, 1,2-, or 1,3 propylene, 2,5-dimethyl-hexene, 2,5-dimethyl-hex-3-yne, and so on. Similarly, a divalent cyclic alkyl group may be 1,2- or 1,3-cyclopentylene, 1,2-, 1,3-, or 1,4-cyclohexylene, and the like. A divalent tricyclo alkyl groups may be any of the tricyclic alkyl groups mentioned herein above. A particularly useful tricyclic alkyl group in this invention is 4,8-bis(methylene)-tricyclo[5.2.1.0^{2,6}]decane.

Alkoxy means straight or branched chain alkoxy having 1 to 10 carbon atoms, and includes, for example, methoxy, ethoxy, n-propoxy, isopropoxy, n-butoxy, isobutoxy, tert-butoxy, pentyloxy, hexyloxy, heptyloxy, octyloxy, nonanyloxy, decanyloxy, 4-methylhexyloxy, 2-propylheptyloxy, and 2-ethyloctyloxy.

The term (meth)acrylate refers to methacrylate or acrylate, and similarly, (meth)acrylic refers to methacrylic or acrylic.

Furthermore, and as used herein, the term “substituted” is contemplated to include all permissible substituents of organic compounds. In a broad aspect, the permissible substituents include acyclic and cyclic, branched and unbranched, carbocyclic and heterocyclic, non-aromatic substituents of organic compounds. Illustrative substituents include, for example, those described hereinabove. The permissible substituents can be one or more and the same or different for appropriate organic compounds. For purposes of this invention, the heteroatoms such as nitrogen may have hydrogen substituents and/or any permissible substituents of organic compounds described herein which satisfy the valencies of the heteroatoms. This invention is not intended to be limited in any manner by the permissible substituents of organic compounds.

Organic groups refer to essentially hydrocarbon groups which may have substituents present. HFydrocarbyl and: hydrocarbylene groups are example of organic groups, further examples being alkyl, alkylene, alkoxy, etc.

The polymers of this invention can be synthesized using techniques known in the art. The polymer of this invention, especially those that can be synthesized by free radical polyvmerization technique, may use for example, 2,2′-azobisisobutyronitrile (AIBN) or a suitable peroxydicarbonate as initiator. A mixture of monomers or the mixture comprising a monomer of derived from structure 1, is added to a reaction vessel together with a solvent, e.g. tetrahydrofuran. and AIBN is added. The reaction is carried out at a suitable temperature for a suitable amount of time to give a polymer with desired properties. The reaction may also be carried out Without a solvent. The temperature may range from about 35° C. to about 150° C., preferably 50° C. to 90° C. for about 5 to 25 hours. The reaction may be carried out at atmospheric pressure or at higher pressures. It has been found that a reaction carried out under a pressure of from about 48,000 Pascals to about 250,000 Pascals gives a polymer with more consistent properties, where examples of such desirable properties are molecular weight, dark film loss, yield, etc. Dark film loss is a measure of the solubility of the unexposed photoresist film in the developing solution, and a minimal film loss is preferred. The polymer may be isolated from any suitable nonsolvent, such as, diethyl ether, hexane or mixture of both hexane and ether, methanol, etc. Other polymerization techniques may be used to obtain a polymer with the desired chemical and physical properties.

The contact angle of a material is measured using accepted methods. The leaching of the components of a photoresist out of the photoresist film can also be measured. The leaching of the components out of the novel photoresist film is less than or equal to 1.6×10⁻¹² mol/cm²/sec.

The novel photoresist comprises Polymer A, Polymer B, at least one photoacid generator and at least one base. The compound capable of producing an acid upon irradiation, a photoacid generator (PAG), of the novel composition is selected from those which absorb at the desired exposure wavelength, preferably 193 nm and 157 nm. Any suitable photoacid generator or mixture of photoacid generators may be used. Suitable examples of the acid generating photosensitive compounds include, without limitation, ionic photoacid generators (PAG), such as diazonium salts, iodonium salts, sulfonium salts, or non-ionic PAGs such as diazosulfonyl compounds, sulfonyloxy imides, and nitrobenzyl sulfonate esters. although any photosensitive compound that produces an acid upon irradiation may be used. The onium salts are usually used in a form soluble in organic solvents, mostly as iodonium or sulfonium salts, examples of which are diphenyliodonium trifluoromethane sulfonate, diphenyliodonium nonafluorobutane sulfonate, triphenylsulfonium trifluromethane sulfonate, triphenylsulfonium nonafluorobutane sulfonate and the like. Other compounds that form an acid upon irradiation that may be used, are triazines, oxazoles, oxadiazoles, thiazoles, substituted 2-pyrones. Phenolic sulfonic esters, bis-sulfonylmethanes, bis-sulfonylmethanes or bis-sulfonyldiazomethanes, triphenylsulfonium tris(trifluoromethylsulfonyl)methide, triphenylsulfonium bis(trifluoromethylsulfonyl)imide, diphenyliodonium tris(trifluoromethylsulfonyl)methide, diphenyliodonium bis(trifluoromethylsulfonyl)imide and their homologues are also possiible candidates. Mixtures of photoactive compounds may also be used, In some embodiments mixtures of photoacid generators is used. The photoresist can comprise a mixture of at least one sulfonium PAG and at least one iodonium PAG, exemplified by, but not limited to 1) a mixture of bis-triphenyllsulfonium octafluorobutaned isu Ifon ate, bis-tert. butyldiphenyliodonium octafluorobutanedisulfonate, and bis(tert.butylphenyl)iodonium bis(pentafluoroethanesulfonyl)imide and 2) a mixture of triphenylsulfonium perfluoropropanedisulfonylimide and bis(triphenylsulfonium) perfluorobutane-1,4-disulfonate, (TPSC4).

Bases or photoactive bases are added to the photoresist to control the profiles of the imaged photoresist and prevent surface inhibition effects, such as T-tops. Nitrogen containing bases are preferred, specific examples of which are amines, such as triethylamine, triethanolamine, aniline, ethylenediamnie, pyridine, tetraalkylammonium hydroxide or its salts. Examples of photosensitive bases are diphenyliodonium hydroxide, dialkyliodonium hydroxide, trialkylsulfonium hydroxide, etc. The base may be added at levels up to 100 mole % relative to the photoacid generator. Although, the term base additive is employed, other mechanisms for removal of acid are possible, for instance by using tetraalkylammonium salts of volatile acids (eg. CF₃CO₂⁻) or nucleophilic acids (eg Br⁻), which respectively remove acid by volatilization out of the film during post-exposure bake or by reaction of a nucleophilic moiety with the acid precursor carbocation (e,g. reaction of tert-butyl carbocation with bromide to form t-butylbromide).

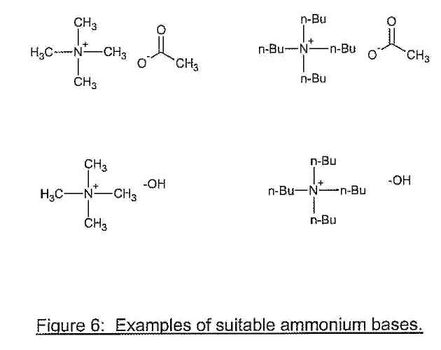

FIG. 6 shows the structures of ammonium derivatives which might be employed as bases. Specific bases are shown in structures 15-19,

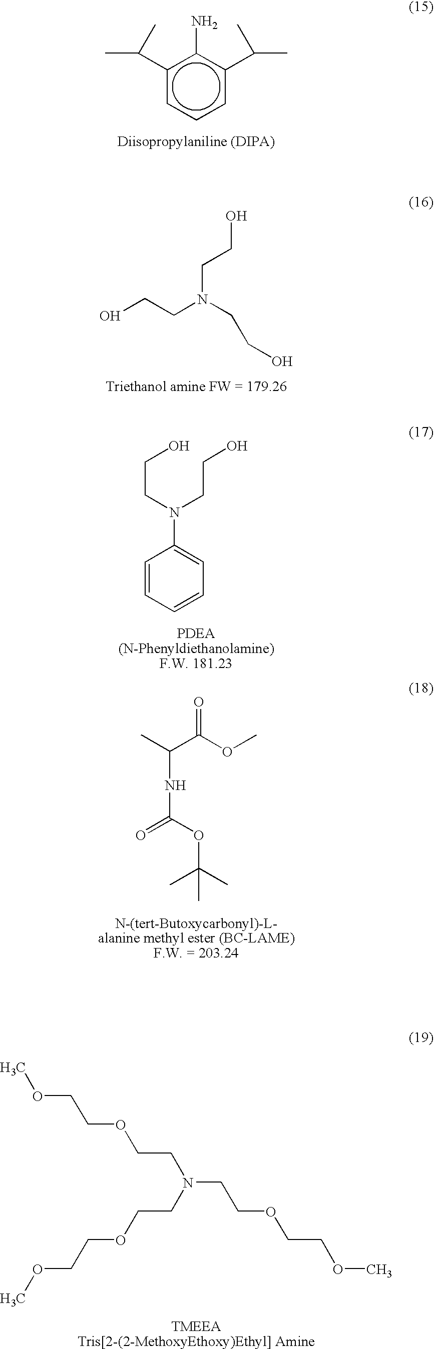

The use of non volatile amine additives is also possible. Preferred amines would be ones having a sterically hindered structure so as to hinder nucleophilic reactivity while maintaining basicity, low volatility and solubility in the resist formulation, such as a proton sponge, 1,5-diazabicyclo[4.3.0]-5-nonene, 1,8-diazabicyclo[5,4,0]-7-undecene, cyclic akylamines, or polyether bearing amines such as described in U.S. Pat. No. 6,274,286. Mixtures of bases may also be used, such as a mixture of diisopropylaniline and trimethoxyethoxyethylamine, or a mixture of ditisopropylaniiine and phenyldiethanolamine or a mixture of diisopropylaniline and N(tert.butoxycarbonyl)-L-alanine methyl ester or a mixture of trimethoxyethoxyethylamine and trioctylamine.

In one embodiment of the present novel composition, it comprises a Polymer A, a Polymer B. a mixture of sulfonium and iodonium PAGs and mixture of diisopropylaniline and phenyidiethanolamine bases. Thus, copolymer obtained by polymerizing ethyladamantylmethacrylate, ethylcyclopentylmethacrylate, hydroxyadamantylacrylate and a-gammabutyrolactone methacrylate was blended with a polymer represented by Structure 1, more specifically structure 2 as represented by poly(1,1,2-Tritluoro-4-[2,2,2-trifluoro-1-hydroxy-1-trifluoromethylethyl]-1,6-heptadiene)(TFTFHTFMFH) that was 70 mole % protected with methoxymethyl group, along with diisopropylaniline and phenyidiethanolamine and bis-triphenylsulfonium: perfluorobutanedisulfonate, ditert.butyliodonium bis(pentafluoroethylsulfonyl)imide and bis-ditert.butyliodonium perfluorobutanedisulfonate.

In another example (7074), a terpolymer obtained by polymerizing Ethyladamantyvmethacrylate, hydroxyadamantyl acrylate and a-gammabutyrolactone acrylate was mixed with polymer represented by structure 1, more specifically structure 2 TFTFHMH that was 70 mole % protected with methoxymethyl group, tris[2-(2-methoxyethoxy)ethyllamine and triphenylsulfonium salt of perfluoropropyldisulfonylimide. In the third example, (83645), tetrapolymer obtained by polymerizing ethyladamantyimethacrylate, hydroxyadamantylacrylate, a-gammabutyrolactonemethacrylate and adamantylmethacrylate was mixed with polymer represented by structure 1, more specifically structure 2 and diisopropylaniline and bis-triphenylsulfonium perfluorobutanedisulfonate, ditert.butyliodonium bis(pentafluoroethylsulfonyl)imide and bis-ditert.butyliodonium perfluorobutanedisulfonate.

In another example (6733), a terpolymer obtained by polymerizing ethyidiamantylmethacrylate, hydroxyadamantylacrylate and gamma-butyrolactonemethacrylate was mixed with polymer whose structure is represented by srtucture 1, more specifically structure 2, TFTFHMH that was 70 mole % protected with methoxymethyl group, and diisopropylaniline and bis-triphenylsulfonium perfluorobutanedisulfonate, ditert.butyliodonium bis(pentafluoroethylsulfonyl)imide and bis-ditert.butyliodonium perfluorobutanedisulfonate.

In yet another example (6734), terpolymer obtained by polymerizing ethyidiamantyl methacrylate, hydroxyadamantyl acrylate and gamma-butyrolactone acrylate was mixed with polymer whose structure is represented in structure 1, more specifically structure 2 TFTFHMH that was 70 mole % protected with methoxymethyl group, and diisopropylaniline and bis-triphenylsulfonium perfluorobutanedisulfonate, ditert.butyliodonium bis(pentafluoroethylsulfonyi)mide and bis-ditert.butyliodonium perfluorobutanedisulfonate.

In another example, (7095) a copolymer obtained by polymerizing ethyladamantylmethacrylate, 3-oxo-1-adamantyloxymethyl methacrylate, hydroxyadamantylacrylate and a-gammabutyrolactone methacrylate was blended with a polymer represented by structurel, more specifically structure 2 TFTFHMH that was 70 mole % protected with methoxyrmethyl group, along with diisopropylaniline and phenyidiethanolamine and bis-triphenylsulfonium perfluorobutaneedisulfonate, ditert.butyliodonium bis(pentafluoroethylsulfonyllimide and bis-ditert.butyliodonium perhluorobutanedisulfonate.

In another example, (7295) a copolymer obtained by polymerizing Ethyladamantylmethacrylate, adamantyloxyrmethylmethacrylate, hydroxyadamantylacrylate and a-gammabutyrolactone methacrylate and adamantylmethacrylate was blended with a polymer represented by structure 1, more specifically structure 2 TFTFHMH that was 70 mole % protected with methoxymethyl group, along with diisopropylaniline and phenyldiethanolamine and bis-triphenylsulfonium perfluorobutanedisulfonate, ditert.butyliodonium bis(pentafluoroethylsulfonyl)imide and bis-ditert.butyliodonium perfluorobutanedisulfonate.

The photoresist of the present invention may contain other components as additives, such as surfactants, dyes, and other secondary polymers.

The photoresist composition is formed by blending the ingredients in a suitable photoresist solvent. In the preferred embodiment, the amount of polymer mixture in the photoresist preferably ranges from 90% to about 99.5% and more preferably from about 95% to about 99% based on the weight of the solid; i.e., non-solvent photoresist components. In the preferred embodiment, the photoactive compound is present in the photoresist in an amount of from about 0.5% to about 10% preferably from about 4% to about 6% based on the weight of the solid photoresist components.

The solid components of the antireflection coating composition are mixed with a solvent or mixtures of solvents that dissolve the solid components of the antireflective coating. Suitable solvents for the antireflective coating composition may include, for example, a glycol ether derivative such as ethyl cellosolve, methyl cellosolve, propylene glycol monornethyl ether, diethylene glycol monomethyl ether, diethylene glycol: monoethyl ether, dipropylene glycol dimethyl ether, propylene glycol n-propyl ether, or diethylene glycol dimethyl ether; a glycol ether ester derivative such as ethyl cellosolve acetate, methyl cellosolve acetate, or propylene glycol monomethyl ether acetate; carboxylates such as ethyl acetate, n-butyl acetate and amyl acetate; carboxylates of di-basic acids such as diethyloxylate and diethylmalonate; dicarboxylates of glycols such as ethylene glycol diacetate and propylene glycol diacetate; and hydroxy carboxylates such as methyl lactate, ethyl lactate, ethyl glycolate, and ethyl-3-hydroxy propionate, a ketone ester such as methyl pyruvate or ethyl pyruvate; an alkoxycarboxylic acid ester such as methyl 3-methoxypropionate, ethyl 3-ethoxypropionate, ethyl 2-hydroxy-2-methylpropionate, or methylethoxypropionate; a ketone derivative such as methyl ethyl ketone, acetyl acetone, cyclopentanone, cyclohexanone or 2-heptanone; a ketone ether derivative such as diacetone alcohol methyl ether; a ketone alcohol derivative such as acetol or diacetone alcohol; a ketal or acetal like 1,3 dioxalne and diethoxypropane; lactones such as butyrolactone and gamma valerolactone; an amide derivative such as dimethylacetamide or dimethylformamide, anisole, and mixtures thereof. Mixtures of solvents are also used.

The prepared photoresist composition solution can be applied to a substrate by any conventional method used in the photoresist art, including dipping, spraying, whirling and spin coating. When spin coating, for example, the photoresist solution can be adjusted with respect to the percentage of solids content, in order to provide coating of the desired thickness, given the type of spinning equipment utilized and the amount of time allowed for the spinning process. Suitable substrates include silicon, aluminum, polymeric resins, silicon dioxide, doped silicon dioxide, silicon nitride, tantalum, copper, polysilicon. ceramics, aluminum/copper mixtures; gallium arsenide and other such Group III/V compounds. The photoresist may also be coated over antireflective coatings.

The photoresist composition solution is then coated onto the substrate, and the substrate is treated at a temperature from about 70° C. to about 150° C. for from about 30 seconds to about 180 seconds on a hot plate or for from about 15 to about 90 minutes in a convection oven. This temperature treatment is selected in order to reduce the concentration of residual solvents in the photoresist, while not causing substantial thermal degradation of the solid components, In general, one desires to minimize the concentration of solvents and this first temperature treatment is conducted until substantially all of the solvents have evaporated and a thin coating of photoresist composition, on the order of half a micron (micrometer) in thickness, remains on the substrate. In a preferred embodiment the temperature is from about 95° C. to about 160° C., and more preferably from about 95° C. to about 135° C. The treatment is conducted until the rate of change of solvent removal becomes relatively insignificant. The temperature and time selection depends on the photoresist properties desired by the user, as well as the equipment used and commercially desired coating times. The coating substrate can then be imagewise exposed to actinic radiation, e.g., ultraviolet radiation, at a wavelength of from about 100 nm (nanometers) to about 300 nm, x-ray, electron beam, ion beam or laser radiation, in any desired pattern, produced by use of suitable masks, negatives, stencils, templates, etc.

In the embodiment where immersion lithography is used to expose the photoresist, the photoresist coating may optionally have a top coating to prevent contamination problems. The coating substrate can then be imagewise exposed to actinic radiation by immersion lithography, e.g., ultraviolet radiation, at a wavelength of from about 100 nm (nanometers) to about 450 nm, x-ray, electron beam, ion beam or laser radiation, in any desired pattern, produced by use of suitable masks, negatives, stencils, templates, etc. A typical immersion liquid used comprises water

The photoresist is then subjected to a post exposure second baking or heat treatment before development. The heating temperatures may range from about 90° C. to about 160° C., more preferably from about 100° C. to about 130° C. The heating may be conducted for from about 30 seconds to about 5 minutes, more preferably from about 60 seconds to about 90 seconds oh a hot plate or about 15 to about 45 minutes by convection oven.

The exposed photoresist-coated substrates are developed to remove the image-wise exposed areas by immersion in a developing solution or developed by spray, puddle or spray-puddle development process. The solution is preferably agitated, for example, by nitrogen burst agitation. The substrates are allowed to remain in the developer until all, or substantially all, of the photoresist coating has dissolved from the exposed areas. Developers include aqueous solutions of ammonium or alkali metal hydroxides or supercritical carbon dioxide. One preferred developer is an aqueous solution of tetramethyl ammonium hydroxide. Surfactants may also be added to the developer composition. After removal of the coated wafers from the developing solution, one may conduct an optional post-development heat treatment or bake to increase the coating's adhesion and chemical resistance to etching conditions and other substances. The post-development heat treatment can comprise the baking of the coating and substrate below the coating's softening point or UV hardening process. in industrial applications, particularly in the manufacture of microcircuitry units on silicon/silicon dioxide-type substrates, the developed substrates may be treated with a buffered, hydrofluoric acid etching solution or preferably, dry etching. In some cases metals are deposited over the imaged photoresist.

Each of the documents referred to above are incorporated herein by reference in its entirety, for all purposes. The following specific examples will provide detailed illustrations of the methods of producing and utilizing compositions of the present invention. These examples are not intended, however, to limit or restrict the scope of the invention in any way and should not be construed as providing conditions, parameters or values which must be utilized exclusively in order to practice the present invention.

### EXAMPLES

Static contact angle (SCA) data were collected using VCA 2500XE (Video Contact Angle System) from AST Products, Inc. (9 Linnell Circle, Billerica, Mass. 01821) using OmniSolv water from EM Science (480 Democrat Road, Gibbstown, N.J. 08027) or AZ® 300MIF Developer (available from AZ Electronic Materials USA Corp., 70, Meister Ave., Somerville, N.J. 08876). Tests were carried out in Glass-1000 Fab environment. Static contact angle were reported as average value from more than six measurements.

The leaching of the components of a photoresist out of the photoresist film was measured by O-ring method. 60 s of soaking time, 8 ml of water and 20 cm² of water-material surface contact area were employed. PAG anion concentration in ng/ml of water sample was measured using Liquid Chromatography/Mass Spectroscopy/Mass Spectroscopy LC/MS/MS technique.
EAdMA refers to 2-ethyl-2-ad amantylmethacrylate
ECPMA refers to 2-ethyl-2-cyclope ntyl methacrylate
HAdA refers to 3-hydroxy-1-adamantylacrylate
a-GBLMA refers to alpha-gammabutyrolactonemethacrylate
EDiMA refers to 2-ethyl-2-diamantyimethacryalte
AdOMMA refers to Adamantyloxymethylmethacrylate
AdMA refers to Ad amantylmethacrylate
EDIMA refers to 2-ethyl-2d-diamantylmethacrylate
AdOM MA(3) refers to 3-OXO-1-adama ntyloxymethylmethacryalte

### EXAMPLE 1

### Synthesis of Poly(EAdM-A/ECPMA/HAdA/a-GBLMA)

In a 500 mL 4-neck flask were taken 18.69 g of EAdMA, 13.74 g of ECPMA, 33.45 g of HAdA, 34.19 g of a-GBLMA and 5 g of Perkadox-16 free radical initiator (available Akzo-Nobel Polymer Chemicals, LLC, 300 South riverside Plaza, Chicago, Ill. 60606, USA) along with 156 g of tetrahydrofuran (THF) solvent. The contents of the flask were allowed to become homogeneous while stirring and a dynamic blanket of nitrogen was provided. Once homogeneous, the contents of the flask were brought to reflux and reflux continued for 5 hours. At the end of 5 hours, the reaction contents were brought down to room temperature and precipitated in methanol and then in hexanes and dried in vacuo to obtain 55 g of polymer with an Mw of 17,414 with a polydispersity of 1.49.

### EXAMPLE 2

### Synthesis of Poly(EAdMA/HAdA/a-GBLMA)

In a 3 L 4-neck flask were taken 350.95 g of EAdMA, 125.55 g of HAdA, 132.38 g of a-GBLA and 91.30 g of AIBN free radical initiator along with 1300 g of THF. The synthetic method as in example 1 was used. 352 g of polymer with an Mw of 8,866 with a polydispersity of 1.70 was obtained.

### EXAMPLE 3

### Synthesis of Poly(EAdMA/HAdA/a-GBLMA/AdMA)

In a 3 L 4-neck flask were taken 237.68 g of EAdMA, 142 g of HAdA, 218.20 g of a-GBLMA, 70.30 g of Adamantylmethacrylate and 33.26 g of perkadox-16 free radical initiator along with 1300 g of THF. The synthetic method as in example 1 was used. 496 g of polymer with an Mw of 14,963 with a polydispersity of 1.92 was obtained.

### EXAMPLE 4

### Synthesis of Poly(EDiMA/HAdA/a-GBLA)

In a 500 mL 4-neck flask were taken 14.06 g of EDiMA, 10.36 g of HAdA, 9.72 g of a-GBLA and 3.39 g of Perkadox-16 free radical initiator along with 112.50 g of THF. The synthetic method as in example 1 was used. 11.82 g of polymer with an Mw of 9913 with a polydispersity of 1.57 was obtained.

### EXAMPLE 5

### Synthesis of Poly(EAdMA/AdOMMA(3)/HAdA/a-GBLMA)

In a 500 mL 4-neck flask were taken 8.61 g of EAdMA, 9.19 g of AdOMMA(3), 20.52 g of HAdA, 11.82 g of a-GBLMA and 5 g of Perkadox-16 free radical initiator along with 165 g of THF The synthetic method as in example 1 was used. 18.36 g of polymer with an Mw of 11,131 with a polydispersity of 1.63 was obtained.

### EXAMPLE 6

### Synthesis of Poly(EDiMA/HAdA/a-GBLMA)

In a 500 mL 4-neck flask were taken 15.28 g of EDiMA, 11.32 g of HAdA, 7.46 g of a-GBLMA and 3.39 g of Perkadox-16 free radical initiator along with 112.50 g of THF. The synthetic method as in example 1 was used. 15.97 g of polymer with an Mw of 9657 with a polydispersity of 1.61 was obtained.

### EXAMPLE 7

### Synthesis of Poly(EAdMA/AdOMMA(3)/HAdA/a-GBLMA/AdMA)

In a 500 mL 4-neck flask were taken 16 g of EAdMA, 7.98 G of AdOMMA, 14.20 g of HAdA, 21.62 g of a-GBLMA. 7.20 g of AdMA and 3.31 g of Perkadox-16 free radical initiator along with 130 g of THF. The synthetic method as in example 1 was used. 57 g of polymer with an Mw of 18,291 with a polydispersity of 2.21 was obtained.

### COMPARATIVE PHOTORESIST EXAMPLE 1

1.2151 g of Poly(EAdMA/ECPMA/HAdA/a-GBLMA) 15/15130140 polymer made in polymer synthesis example (1), 0.0282 g of bis(p-tertbutyl phenyl)iodonium perfluoroethanesulfonylimide (BDPINC2), 0.0323 g of bis(triphenylsulfonium) perfluorobutane-1,4-disulfonate, (TPSC4), 0.0655 grams of bis(p-tertiarybutylphenyl)iodonium perfluorobutane-1,4-disulfonate, 0.0071 grams of N,N-diisopropylaniline, 0.0018 g of phenyl-N,N-diethanolamine, 0.0036 grams of FC4430 surfactant supplied by 3M Corporation Were dissolved in 22.6545 g of methylalphahydroxyisobutyrate (MHIB) and 5.6007 g of propyleneglycolmonomethylether and 0.3912 g of gamma valerolactone. The solution was thoroughly mixed for complete dissolution and filtered using 0.2 um filter.

A silicon substrate coated with a bottom antireflective coating (B.A.R.C.) was prepared by spin coating the bottom anti-reflective coating solution (AZ® ArF-38, B.A.R.C. available from AZ® Electronic Materials Corporation, Somerville, N.J., USA) onto the silicon substrate and baking at 225° C. for 90 sec. The B.A.R.C film thickness was 87 nm. The photoresist solution prepared in this Example was then coated on the B.A.R.C coated silicon substrate. The spin speed was adjusted such that the photoresist film thickness was 120 nm, soft baked at 100° C./60 s, exposed with Nikon 306D 0.85NA 193 nm radiation, and dipole illumination using 6% half-tone mask. The exposed wafer was post exposure baked at 110° C/60 s, and developed using a 2.38 weight % aqueous solution of tetramethyl ammonium hydroxide for 30 sec. The line and space patterns were then measured on a AMAT 3D CD SEM (scanning electron microscope). The photosensitivity to print 70 nm (1:1) trench photoresist pattern without mask bias was 37 mJ/cm², with a depth of focus (DoF) of 0.325 um and the average 3sigma line edge roughness/line width roughness (LER/LWR) at ±0.10 μm DoF was 4.48 J 6.60 nm. This photoresist exhibited a static water contact angle of 63.05°

### COMPARATIVE PHOTORESIST EXAMPLE 2

2.9049 g of Poly(EAdMA/HAdA/a-GBLA) 50/20/30 polymer made in polymer synthesis example (2), 0.0549 g of triphenylsulfonium perfluoropropanesulfonylimide (TPS_PFSI_Cy6), 0.0258 g of bis(triphenylsulfonium) perfluorobutane-1,4-disulfonate, (TPSC4), 0.0145 g of tris[2-(2-methoxyethoxy)ethyl]amine, 0.0060 grams of FC4430 surfactant supplied by 3M Corporation were dissolved in 46.9940 g of a 60/40 (w/w) mixture of propyleneglycol monomethylether acetate and ethyl lactate. The solution was thoroughly mixed for complete dissolution and filtered using 0.2 um filter.

A silicon wafer coated with a bottom antireflective coating (B.A.R.C.) was prepared by spin coating the bottom anti-reflective coating solution (AZ® 1C5D, B.A.R.C. available from AZ Electronic Mhaterials Corporation, Somerville, N.J.) onto the silicon substrate and baking at 200° C. for 60 sec. The B.A.R.C film thickness was 37 nm. The photoresist solution prepared in this Example was then coated on the B.A.R.C coated silicon substrate. The spin speed was adjusted such that the photoresist film thickness was 150 nm, soft baked at 105° C./60 s, exposed with Nikon 306D 0.85NA & conventional illumination using 6% half-tone mask. The exposed wafer was post exposure baked at 120° C./60 s, and developed using a 2.38 weight % aqueous solution of tetramethyl ammonium hydroxide for 60 sec. The photoresist contact hole patterns were then inspected using a AMAT 3D CD SEM. The photosensitivity to print 90 nm contact hole with pitch 200 nm photoresist pattern with 30 nm mask bias was 56 mJ/cm², with a DoF of 0.25 um.

### PHOTORESIST EXAMPLE 3

0.012 g of homopolymer of 1,1,2-trifluoro-4-(2,2,2-trifluoro-1-hydroxy-1-trifluoromethylethyl)-1,6-heptadiene (CF₂═(═FCH₂CH(C(CF₃)₂(OH))CH₂CH═CH₂ (TFTFHMH)), that was 70 mole % protected with methoxymethyl group,corresponding to 1 weight percent of polymer (available from Asahi Glass Co., Ltd., 12-1 Yurakucho 1-Chome, Chiyoda-Ku, Tokyo 100-8405, Japan) was mixed with 30 g of photoresist from Comparative Example 1. The resultant mixture was placed on a roller for 8 h and filtered using 0.2 um filter.

The photoresist of this example was processed in the same manner as described in Comparative Photoresist Example 1. The photoresist had a photosensitivity of 38 mJ/cm² for printing 70 nm (1:1) trench without mask bias, with a DoF of 0.30 um, and the average 3sigma LER/LWR values at ±0.10 um DoF was 4.88 and 7.17 nm respectively.

The photoresist of this example had a water static contact of 87.53° and was much higher than that of the Comparative Photoresist Example 1.

### PHOTORESIST EXAMPLE 4

0.0230 g of homopolymer of (TFTFHMH), that was 70 mole % protected with methoxymethyl group corresponding to 2 weight percent of photoresist polymer (available from Asahi Glass Co., Ltd., Japan) was mixed with 30 g of photoresist from Comparative Example 1. The resultant mixture was placed on a roller for 8 h and filtered using 0.2 um filter.

The photoresist solution prepared in this Example was then coated on the B.A.R.C coated silicon substrate. The spin speed was adjusted such that the photoresist film thickness was 120 nm, and soft baked at 100° C./60 s. This photoresist gave a static water contact angle of 92.20°, which was much higher than Comparative Example 1.

### PHOTORESIST EXAMPLE 5

0.0156 g of homopolymer of TFTFHMH that was 70 mole % protected with methoxymethyl group corresponding to 2.5 weight percent of polymer (available from Asahi Glass Co., Ltd., Japan.) was mixed with 15 g of photoresist from Comparative Example 1. The resultant mixture was placed on a roller for 8 h and filtered using 0.2 um filter.

The photoresist solution prepared in this Example was then coated on the B.A.R.C coated silicon substrate. The spin speed was adjusted such that the photoresist film thickness was 120 nm, soft baked at 100° C./60 s. This photoresist gave a static water contact angle of 92.52°, which was much higher than Comparative Example 1.

### PHOTORESIST EXAMPLE 6

0.0312 g of homopolymer of TFTFHMH that was 70 mole % protected with methoxymethyl group, corresponding to 5 weight percent of polymer (available from Asahi Glass Co., Ltd., Japan) was mixed with 15 g of photoresist from Comparative Example 1. The resultant mixture was placed on a roller for 8h and filtered using 0.2 um filter.

The photoresist solution prepared in this Example was then coated on the B.A.R.C coated silicon substrate. The spin speed was adjusted such that the photoresist film thickness was 120 nm, soft baked at 100° C./60 s. This photoresist gave a static water contact angle of 92.48° which was much higher than Comparative Example 1.

### PHOTORESIST EXAMPLE 7

0.0115 g of homopolymer of 1,1,2-trifluoro-4-(2,2,2-trifluoro-1-hydroxy-1-trifluoromethylethyl)-1,6-heptadiene (CF₂═CFCH₂CH(C(CF₃)₂(OH))CH₂CH═CH₂ (TFTFHMH)), that was 30 mole % protected with methoxymethyl group, corresponding to 1 weight percent of polymer (available from Asahi Glass Co., Ltd., Japan) was mixed with 30 g of photoresist from Comparative Example 1. The resultant mixture was placed on a roller for 8 h and filtered using 0.2 um filter.

The photoresist of this example was processed in the same manner as described in Comparative Photoresist Example 1. The photoresist solution prepared in this Example was then coated on the B.A.R.C coated silicon substrate. The spin speed was adjusted such that the photoresist film thickness was 420 nm, soft baked at 100° C./60 s, This photoresist gave a static water contact angle 85.55°

### PHOTORESIST EXAMPLE 8

0.0115 g of homopolymer of 1,1,2-trifluoro-4-(2,2,2-trifluoro-1-hydroxy-1-trifluoromethylethyl)-1,6-heptad iene (CF₂═CFCH₂CH(C(CF₃)₂(OH))C(H₂CH═CH₂ (TFTFHMH)), that was 50 mole % protected with methoxymethyl group corresponding to 1 weight percent of polymer (available from Asahi Glass Co., Ltd. Japan) was mixed with 30 g of photoresist from Comparative Example 1. The resultant mixture was placed on a roller for 8 h and filtered using 0.2 um filter,

The photoresist of this example was processed in the same manner as described in Comparative Photoresist Example 1 The photoresist solution prepared in this Example was then coated on the B.A.R.C coated silicon substrate. The spin speed was adjusted such that the photoresist film thickness was 120 nm, soft baked at 100° C./60 s. This photoresist gave a static water contact angle 81.83°

### PHOTORESIST EXAMPLE 9

0.0164 g of homopolymer of TFTFHMH that was 70 mole % protected with methoxymethyl group was mixed with 15 g of photoresist from Comparative Example 2. The resultant mixture was placed on a roller for 8h and filtered using 0.2 um filter.

The photoresist of this example was processed in the same manner as described in Comparative Example 2. The photoresist had a photosensitivity of 54 mJ/cm² for printing 90 nm contact hole with a pitch of 200 nm photoresist pattern with 30 nm of mask bias. The DoF was 0.25 um.

The photoresist of this Example had water static contact angle of 90.38°, which was much higher than Comparative Example 2.

### COMPARATIVE PHOTORESIST EXAMPLE 10

0.9208 g of Poly(EAdMA/HAdA/a-GBLMA/AdMA) 30/20140/10 polymer made in polymer synthesis example (3) 0.0285 g of bis(ptertbutyl phenyl)iodonium perfluoroethanesulfonylimide (BDPINC2), 0.0245 g of bis(triphenylsulfonium) perfluorobutane-1,4-disulfonate, (TPSC4), 0.0211 grams of bis(p-tertiarybutylphenyl)iodonium perfluorobutane-1,4-disulfonate, 0.0051 grams of N,N-diisopropylaniline, 0.0030 grams of FC4430 surfactant supplied by 3M Corporation were dissolved in 19.1970 g of MHIB and 4.7020 g of propyleneglycolmonomethylether and 0.0980 g of gamma valerolactone. The solution was thoroughly mixed for complete dissolution and filtered using 0.2 um filter.

A silicon substrate coated with a bottom antireflective coating (B3A.R.C.) was prepared by spin coating the bottom anti-reflective coating solution (AZ® ArF-38, B.A.R.C. available from AZ® Electronic Materials Corporation, Somerville, N.J.) onto the silicon substrate and baked at 225° C. for 90 sec. The B.A.R.C film thickness was 87 nm. The photoresist solution prepared in this Example was then coated on the B.A.R.C coated silicon substrate. The spin speed was adjusted such that the photoresist film thickness was 120 nm, soft baked at 100° C./60 s. This photoresist gave a static water contact angle of 71.69°

### PHOTORESIST EXAMPLE 11

0.0552 g of homopolymer of TFTFHMH that was 70 mole % protected with methoxymethyl group was mixed with 15 g of the photoresist from Comparative Example 8. The solution was thoroughly mixed for complete dissolution and filtered using 0.2 um filter.

A silicon substrate coated with a bottom antireflective coating (B.A.R.C.) was prepared by spin coating the bottom anti-reflective coating solution (AZ® ArF-38, B.A.R.C. available from AZ Electronic Materials Corporation, Somerville, N.J.) onto the silicon substrate and baking at 225° C. for 90 sec. The B.A.R.C film thickness was 87 nm. The photoresist solution prepared in this Example was then coated on the B.A.R.C coated silicon substrate. The spin speed was adjusted such that the photoresist film thickness was 120 nm, soft baked at 100° C./60 s. This photoresist exhibited a static water contact angle of 87.85° which was much higher than Comparative Photoresist Example 8.

### COMPARATIVE EXAMPLE 12

0.7200 g of Poly(EDiMA/HAdA/a-GBLA, 30/30/40) polymer made in polymer synthesis example (4), 0.0167 g of bis(p-tertbutyl phenyl)iodonium perfluoroethanesulfonylimide (BDPINC2), 0.0192 g of bis(triphenylsulfonium) perfluorobutane-1,4-disulfonate, (TPSC4), 0.0388 grams of bis(p-tertiarybutylphenyl)iodonium perfluorobutane-1,4-disulfonate, 0.0053 grams of N,N-diisopropylaniline, 0.0030 grams of FC4430 surfactant supplied by 3M Corporation were dissolved in 19.3570 g of MHIB and 4.7634 g of propyleneglycolmonomethylether and 0.0766 g of gamma valerolactone. The solution was thoroughly mixed for complete dissolution and filtered using 0.2 um filter.

A silicon substrate coated with a bottom antireflective coating (B.A.R.C.) was prepared by spin coating the boffom anti-reflective coating solution. AZ® ArF-38, B.A.R.C., onto the silicon substrate and baked at 225° C. for 90 sec. The B.A.R.C film thickness was 87 nm. The photoresist solution of this example was then coated on the B.A.R.C coated silicon substrate. The spin speed was adjusted such that the photoresist film thickness was 120 nm, soft baked at 100° C./60 s. This resist exhibits a static water contact angle of 66.66°.

### PHOTORESIST EXAMPLE 13

0.0432 g of homopolymer TFTFHMH that was 70 mole % protected with methoxymethyl group was mixed with 15 g of the photoresist from Comparative Example 10. The solution was thoroughly mixed for complete dissolution and filtered using 0.2 um filter.

A silicon substrate coated with a bottom antireflective coating (B.A.R.C.) was prepared by spin coating the bottom anti-reflective coating solution (AZ® ArF-38, B.A.R.C. available from AZ Electronic Materials Corporation, Somerville, NJ.). onto the silicon substrate and baking at 225° C. for 90 sec. The B.A.R.C film thickness was 87 nm. The photoresist solution prepared in this Example was then coated on the B.A.R.C coated silicon substrate. The spin speed was adjusted such that the photoresist film thickness was 120 nm, soft baked at 100° C./60 s. This photoresist gave a static water contact angle of 86.88° which was much higher than Comparative Photoresist Example 10.

### COMPARATIVE PHOTORESIST EXAMPLE 14

0.4725 g of Poly(EAdMA/AdOMMA(3)/HAdA/a-GBLMA) 15/15/40/30) polymer made in polymer synthesis example (5), 0.0110 g of bis(p-tertbutyl phenyl)iodonium perfluoroethanesulfonylimide (BDPINC2), 0.0126 g of bis(triphenylsulfonium) perfluorobutane-1,4-disulfonate, (TPSC4), 0.0255 grams of bis(p-tertiarybutylphenyl)iodohium perfluorobutane-1,4-disulfonate, 0.0028 grams of N,N-diisopropylaniline, 0.0007 g of phenyl-N,N-diethanolamine, 0.0018 grams of FC4430 surfactant supplied by 3M corporation were dissolved in 11.5782 g of MHIB and 2.8447 g of propyleneglycolmonomethylether and 0.0503 g of gamma valerolactone. The solution was thoroughly mixed for complete dissolution and filtered using 0.2 m filter.

A silicon substrate coated with a bottom antireflective coating (B.A.R.C.) was prepared by spin coating the bottom anti-reflective coating solution: (AZ® ArF-38, B.A.R.C. available from AZ Electronic Materials Corporation, Somerville, N.J.) onto the silicon substrate and baking at 225° C. for 90 sec. The B.A.R.C film thickness was 87 nm. The photoresist solution prepared in this Example was then coated on the B.A.R.C coated silicon substrate. The spin speed was adjusted such that the photoresist film thickness was 120 nm, soft baked at 100° C./60 s. This photoresist gave a static water contact angle of 64.08°

### PHOTORESIST EXAMPLE 15

0.0472 g of homopolymer of TFTFHMH that was 70 mole % protected with methoxymethyl group was mixed with 15 g of the photoresist from Comparative Example 12. The solution was thoroughly mixed for complete dissolution and filtered using 0.2 um filter.

A silicon substrate coated with a bottom antireflective coating (B.A.R.C.) was prepared by spin coating the bottom anti-reflective coating solution (AZ® ArF-38, B.A.R.C. available from AZ Electronic Materials Corporation, Somerville, N.J.) onto the silicon substrate and baking at 225° C. for 90 sec. The B.A.R.C film thickness was 87 nm. The photoresist solution prepared in this Example was then coated on the B.A.R.C coated silicon substrate. The spin speed was adjusted such that the photoresist film thickness was 120 nm, soft baked at 100° C./60 s. This photoresist gave a static water contact angle of 87.09° which was much higher than Comparative Photoresist Example 12.

### COMPARATIVE PHOTORESIST EXAMPLE 16

0.7200 g of Poly(EDiMA/HAdA/a-GBLMA, 35/35/30) polymer made in polymer synthesis example (6), 0.0167 g of bis(p-tertbutyl phenyl)iodonium perfluoroethanesulfonylimide (BDPINC2), 0.0192 g of bis(triphenylsulfonium) perfluorobutane-1,4-disulfonate, (TPSC4), 0.0388 grams of bis(p-tertiarybutylphenyl)iodonium perfluorobutane-1,4-disulfonate, 0.0053 grams of N,N-diisopropylaniline, 0.0030 grams of FC4430 surfactant supplied by 3M corporation were dissolved in 19.3570 g of MHIB and 4.7634 g of propyleneglycolmonomethylether and 0.0766 g of gamma valerolactone. The solution was thoroughly mixed for complete dissolution and filtered using 0.2 um filter.

A silicon substrate coated with a bottom antireflective coating (B.A.R.C.) was prepared by spin coating the bottom anti-reflective coating solution, AZ® ArF-38, onto the silicon substrate and baking at 225° C. for 90 sec. The B.A.R.C film thickness was 87 nm. The photoresist solution prepared in this Example was then coated on the B.A.R.C coated silicon substrate. The spin speed was adjusted such that the photoresist film thickness was 120 nm, soft baked at 100° C./60 s. This photoresist gave a static water contact angle of 70.23°

### PHOTORESIST EXAMPLE 17

0.0432 g of homopolymer TFTFHMH that was 70 mole % protected with methoxymethyl group was mixed with 15 g of the photoresist from Comparative Example 14. The solution was thoroughly mixed for complete dissolution and filtered using 0.2 um filter.

A silicon substrate coated with a bottom antireflective coating (B.A.R.C.) was prepared by spin coating the bottom anti-reflective coating solution, AZ® ArF-38 B.A.R.C. onto the silicon substrate and baking at 225° C. for 90 sec. The B.A.R.C film thickness was 87 nm. The photoresist solution prepared in this Example was then coated on the B.A.R.C coated silicon substrate. The spin speed was adjusted such that the photoresist film thickness was 120 nm, soft baked at 100° C./60 s. This photoresist gave a static water contact angle of 86.71° which was much higher than Comparative Photoresist Example 14.

### COMPARATIVE PHOTORESIST EXAMPLE 18

0.7878 g of Poly(EAdMA/AdOMMA/HAdAa-GBLM/AdMA) 20/10/20/40/10) polymer made in polymer synthesis example (7), 0.0183 g of bis(p-tertbutyl phenyl)iodonium perfluoroethanesulfonylimide (BDPINC2), 0.0210 g of bis(triphenylsulfonium) perfluorobutane-1,4-disulfonate,(TPSC4), 0.0425 grams of bis(p-tertiarybutylphenyl)iodonium perfluorobutane-1,4-disulfonate, 0.0019 grams of N,N-diisopropylaniline, 0.0035 g of tris[2-(2-methoxyethoxy)ethyl]amine, 0.0030 grams of FC4430 surfactant supplied by 3M corporation were dissolved in 19.2970 g of MHIB and 4.7412 g of propyleneglycolmonomethylether and 0.0838 g of gamma valerolactone. The solution was thoroughly mixed for complete dissolution and filtered using 0.2 um filter.

A silicon substrate coated with a bottom antireflective coating was prepared by spin coating the bottom anti-reflective coating solution, AZ® ArF-38, B.A.R.C., onto the silicon substrate and baked at 225° C. for 90 sec. The B.A.R.C film thickness was 87 nm. The photoresist solution prepared in this Example was then coated on the B.A.R.C coated silicon substrate. The spin speed was adjusted such that the photoresist film thickness was 120 nm, soft baked at 100° C./60 s. This photoresist gave a static water contact angle of 70.94°

### PHOTORESIST EXAMPLE 19

0.0472 g of homopolymer TFTFHMH that was 70 mole % protected with methoxymethyl group was mixed with 15 g of the photoresist from Comparative Example 16. The solution was thoroughly mixed for complete dissolution and filtered using 0.2 um filter.

A silicon substrate coated with a bottom antireflective coating was prepared by spin coating the bottom anti-reflective coating solution, AZ® ArF-38, B.A.R.C., nto the silicon substrate and baked at 225° C. for 90 sec. The B.A.R.C film thickness was 87 nm. The photoresist solution prepared in this Example was then coated on the B.A.R.C coated silicon substrate, The spin speed was adjusted such that the photoresist film thickness was 120 nm, soft baked at 100° C./60 s. This photoresist gave a static water contact angle of 85.31° which was much higher than Comparative Photoresist Example 16.

Similar experiments were done using 30% protected and 50% protected TFTFHMH polymers.

Similarly, 1) a 50/50 copolymer of 3,5-Bis(hexafluoro-2hydroxy-2-propyl)cyclohexyl methacryl ate and 1-cyclohexyl4,4,4-trifluoro-3-hydroxy-3-(trifluromethyl)but-1-yl methacrylate (BHFHPCHMA-co-CHTFHTFMBMA) as represented by structures 7 & 8 and 2) and a copolymer of (structure 4) [2-fluoro-2-hexafluoroisopropylhydroxymethyl]-5-norbornene and tetrafluoroethylene (FHFPHMNB=co-TFE, supplied by Daikin Chemical Co., Ltd.) were evaluated at different concentration levels with the photoresist mentioned in Comparative Photoresist Example 1 and contact angles measured.

### PHOTORESIST EXAMPLE 20

1.1517 g of Poly(EAdMA/ECPMA/HAdA/a-GBLMA) 15/15/30/40 polymer made in polymer synthesis example (1), 0.01152 g of (BHFHPCHMA-co-CHTFHTFMBMA), 0.0267 g of bis(ptertbutyl phenyl)iodonium perfluoroethanesutlfonylimide (BDPINC2), 0.0306 g of bis(triphenylsulfonium) perfluorobutane-1,4-disulfonate,(TPSC4), 0.0621 grams of bis(p-tertiarybutylphenyl)iodonium perfluorobutane-1,4-disulfonate, 0.0061 grams of N,N-diisopropylaniline, 0.0016 g of phenyl-N,Ndiethanolamine, 0.0031 grams of FC4430 surfactant supplied by 3M Corporation were dissolved in 22.9739 g of MHIB and 5.6217 g of propyleneglycolmonomethylether and 0.1226 g of gamma valerolactone. The solution was thoroughly mixed for complete dissolution and filtered using 0.2 um flIter.

A silicon substrate coated with a bottom antireflective coating was prepared by spin coating the bottom anti-reflective coating solution, AZ® ArF-38, B.A.R.C., onto the silicon substrate and baking at 225° C. for 90 sec. The B.A.R.C film thickness was 87 nm. The photoresist solution prepared in this Example was then coated on the B.A.R.C coated silicon substrate, The spin speed was adjusted such that the photoresist film thickness was 120 nm and soft baked at 100° C./60 s. This photoresist gave a static water contact angle of 74.00°

### PHOTORESIST EXAMPLE 21

1.1517 g of Poly(EAdMA/ECPMHA/HAdA/a-GBLMA) 15/15/30/40 polymer made in polymer synthesis example (1), 0.0230 g of (BHFHPCHMA-co-CHTFHTFMBMA), 0.0267 g of bis(p-tertbutyl phenyl)iodonium perfluoroethanesulfonylimide (BDPINC2), 0.0306 g of bis(triphenylsulfonium) perfluorobutane-1,4-disulfonate, (TPSC4), 0.0621 grams of bis(p-ertiarybutylphenyl)iodonium perfluorobutane-1,4-disulfonate, 0.0061 grams of N,N-diisopropylaniline, 0.0016 by of phenyl-N,N-diethanolamine, 0.0031 grams of FC4430 surfactant supplied by 3M Corporation were dissolved in 22.9739 g of MHIB and 5.6217 g of propyleneglycolmonomethylether and 0.1226 g of gamma valerolactone. The solution was thoroughly mixed for complete dissolution and filtered using 0.2 um filter.

A silicon substrate coated with a bottom antireflective coating was prepared by spin coating the bottom anti-reflective coating solution, AZ® ArF-38 B.A.R.C., onto the silicon substrate and baking at 225° C for 90 sec. The B.A.R.C film thickness was 87 nm. The photoresist solution prepared in this Example was then coated on the B.A.R.C coated silicon substrate. The spin speed was adjusted such that the photoresist film thickness was 120 nm and soft baked at 100° C./60 s. This photoresist gave a static water contact angle of 78.98°

### PHOTORESIST EXAMPLE 22

1.1517 g of Poly(EAdMA/ECPMA/HAdA/a-GBLMA) 15/15/30/40 polymer made in polymer synthesis example (1), 0.0345 g of (BHFHPCHMA-co-CHTFHTFMBMA), 0.0267 g of bis(p-tertbutyl phenyl)iodonium perfluoroethanesulfonylimide (BDPINC2), 0.0306 g of bis(triphenylsulfoniu m) perfluorobutane-1,4-disulfonate, (TPSC4), 0.0621 grams of bis(p-tertiarybutylphenyl)iodonium perfluorobutane-1,4-disulfonate, 0.0061 grams of N,N-diisopropylaniline, 0.0016 g of phenyl-N,N-diethanolamine, 0.0031 grams of FC4430 surfactant supplied by 3M Corporation were dissolved in 22.9739 g of MHIB and 5.6217 g of propyleneglycolmonomethylether and 0.1226 g of gamma valerolactone. The solution was thoroughly mixed for complete dissolution and filtered using 0.2 um filter.

A silicon substrate coated with a bottom antirefiective coating was prepared by spin coating the bottom anti-reflective coating solution, AZ® ArF-38, B.A.R.C., onto the silicon substrate and baked at 225° C for 90 sec. The B.A.R.C film thickness was 87 nm. The photoresist solution prepared in this Example was then coated on the B.A.R.C coated silicon substrate. The spin speed was adjusted such that the photoresist film thickness was 120 nm and soft baked at 100° C./60 s. This photoresist gave a static water contact angle of 81.60°.

### PHOTORESIST EXAMPLE 23

1.1517 g of Poly(EAdMA/ECPMA/HAdA/a-GBLMA) 15/15/30/40 polymer made in polymer synthesis example (1), 0.0461 g of (BHFHPCHMA-co-CHTFHTFMBMA), 0.0267 g of bis(p-tertbutyl phenyl)iodonium perfluoroethanesulfonylimide (BDPINC2), 0.0306 g of bis(triphenylsulfonium) perfluorobutane-1,4-disulfonate, (TPSC4), 0.0621 grams of bis(p-tertiarybutylphenyl)iodonium perfluorobutane-1,4-disulfonate, 0.0061 grams of N,N-diisopropylaniline, 0.0016 g of phenyl-N,N-diethanolamine, 0.0031 grams of FC4430 surfactant supplied by 3M Corporation were dissolved in 22.9739 g of MHIB and 5.6217 g of propyleneglycolmonomethylether and 0.1226 g of gamma valerolactone. The solution was thoroughly mixed for complete dissolution and filtered using 0.2 um filter.

A silicon substrate coated with a bottom antireflective coating was prepared by spin coating the bottom anti-reflective coating solution, AZ® ArF-38, B.A.R.C., onto the silicon substrate and baking at 225° C. for 90 sec. The B.A.R.C film thickness was 87 nm. The photoresist solution prepared in this Example was then coated on the B.A.R.C coated silicon substrate. The spin speed was adjusted such that the photoresist film thickness was 120 nm and soft baked at 100° C./60 s. This photoresist gave a static water contact angle of 84.31°

### PHOTORESIST EXAMPLE 24

1.1517 g of Poly(EAdMA/ECPMA/HAdA/a-GBLMA) 15/15/30/40 polymer made in polymer synthesis example (1), 0.01152 g of (FHFPHMNB=co-TFE). 0.0267 g of bis(p-tertbutyl phenyl)iodonium perfluoroethanesulfonylimide (BDPINC2), 0.0306 g of bis(triphenylsulfonium) perfluorobutane-1,4-disulfonate,(TPSC4), 0.0621 grams of bis(p-tertiarybutylphenyl)iodonium perfluorobutane-1,4-disulfonate, 0.0061 grams of N,N-diisopropylaniline, 0.0016 g of phenyl-N,N-diethanolamine, 0.0031 grams of FC4430 surfactant supplied by 3M Corporation were dissolved in 22.9739 g of MHIB and 5.6217 g of propyleneglycolmonomethylether and 0.1226 g of gamma valerolactone. The solution was thoroughly mixed for complete dissolution and filtered using 0.2 um filter.

A silicon substrate coated with a bottom antireflective coating was prepared by spin coating the bottom anti-reflective coating solution, AZ® ArF-38, B.A.R.C., onto the silicon substrate and baking at 225° C. for 90 sec. The B.A.R.C film thickness was 87 nm. The photoresist solution prepared in this Example was then coated on the B.A.R.C coated silicon substrate. The spin speed was adjusted such that the photoresist film thickness was 120 nm and soft baked at 100° C./60 s. This photoresist gave a static water contact angle of 75.60°

### PHOTORESIST EXAMPLE 25

1.1517 g of Poly(EAdMA/ECPMA/HAdA/a-GBLIMA) 15/15/30/40 polymer made in polymer synthesis example (1), 0.0230 g of (FHFPHMNB=co-TFE), 0.0267 g of bis(p-tertbutyl phenyl)iodonium perfluoroethanesulfonylimide (BDPINC2), 0.0306 g of bis(triphenylsulfonium) perfluorobutane-1,4-disulfonate, (TPSC4), 0.0621 grams of bis(p-tertiarybutylphenyl)iodonium perfluorobutane-1,4-disulfonate, 0.0061 grams of N,N-diisopropylaniline, 0.0016 g of phenyl-N,N-diethanolamine, 0.0031 grams of FC4430 surfactant supplied by 3M Corporation were dissolved in 22.9739 g of MHIB and 5.6217 g of propyleneglycotmonomethylether and 0.1226 g of gamma valerolactone. The solution was thoroughly mixed for complete dissolution and filtered using 0.2 um filter.

A silicon substrate coated with a bottom antireflective coating was prepared by spin coating the bottom anti-reflective coating solution, AZ® ArF-38, B.A.R.C., onto the silicon substrate and baked at 225° C. for 90 sec, The B.A.R.C film thickness was 87 nm. The photoresist solution prepared in this Example was then coated on the B.A.R.C coated silicon substrate. The spin speed was adjusted such that the photoresist film thickness was 120 nm and soft baked at 100° C./60 s. This photoresist gave a static water contact angle of 77.58°

### PHOTORESIST EXAMPLE 26

1.1517 g of Poly(EAdMA/ECPMA/HAdA/a-GBLMA) 15/15/30/40 polymer made in polymer synthesis example (1), 0.0346 g of (FHFPHMNB-co-TFE), 0.0267 g of bis(p-tertbutyl phenyl)iodonium perfluoroethanesultonylimide (BDPINC2), 0.0306 g of bis(triphenylsulfonium) perfluorobutane-1,4-disulfonate, (TPSC4). 0.0621 grams of bis(p-tertiarybutylphenyl)iodonium perfluorobutane-1,4-disulfonate, 0.0061 grams of N,N-diisopropylaniline, 0.0016 g of phenyl-N,N-diethanolamine, 0.0031 grams of FC4430 surfactant supplied by 3M Corporation were dissolved in 22.9739 g of MHIB and 5.6217 g of propyleneglycolmonomethylether and 0.1226 g of gamma valerolactone. The solution was thoroughly mixed for complete dissolution and filtered using 0.2 um filter.

A silicon substrate coated with a bottom antireflective coating was prepared by spin coating the bottom anti-reflective coating solution, AZ® ArF-38, B.A.R.C., onto the silicon substrate and baking at 225° C. for 90 sec. The B.A.R.C film thickness was 87 nm. The photoresist solution prepared in this Example was then coated on the B.A.R.C coated silicon substrate. The spin speed was :adjusted such that the photoresist film thickness was 120 nm and soft baked at 1 00“CI60 s. This photoresist gave a static water contact angle of 78.70°

### PHOTORESIST EXAMPLE 27

1.1517 g of Poly(EAdMA/ECPMA/HAdAa-GBLMA) 15/15/30/40 polymer made in polymer synthesis example (1), 0.0461 g of (FHFPHMNB=co-TFE), 0.0267 g of bis(p-tertbutyl phenyl)iodonium perfluoroethanesulfonylimide (BDPINC2), 0.0306 g of bis(triphenylsulfonium) perfluorobutane-1,4-disulfonate, (TPSC4), 0.0621 grams of bis(p-tertiarybutylphenyl)iodonium perfluorobutane-1,4-disulfonate, 0.0061 grams of N,N-diisopropylaniline, 0.0016 g of phenyl-N,N-diethanolamine, 0.0031 grams of FC4430 surfactant supplied by 3M Corporation were dissolved in 22.9739 g of MHIB and 5.6217 g of propyleneglycolmeonomethylether and 0.1226 g of gamma valerolactone. The solution was thoroughly mixed for complete dissolution and filtered using 0.2 um filter.

A silicon substrate coated with a bottom antireflective coating (B,A.R.C.) was prepared by spin coating the bottom anti-reflective coating solution, AZ® ArF-38, B.A.R.C. onto the silicon substrate and baking at 225° C. for 90 sec. The B.A.R.C film thickness was 87 nm. The photoresist solution prepared in this Example was then coated on the B.A.R.C coated silicon substrate. The spin speed was adjusted such that the photoresist film thickness was 120 nm and soft baked at 100° C./60 s. This photoresist gave a static water contact angle of 79.33°

### EXAMPLE 28

The photoresists prepared above were also used to measure the static contact angle in an aqueous alkaline developer, AZ 300MIF (2.38 wt % aqueous tetramethyl ammonium hydroxide) Developer.

TABLE 1
Summary of Static Contact Angle Data with Water and Developer

| | Static | | Static | Static |
|---|---|---|---|---|
| | Contact | Static Contact | Contact | Contact |
| | Angle | Angle | Angle | Angle |
| Example | No additive | With additive | No additive | With additive |
| Number | Water | | Developer | |
| 11 | 71.69 | 87.85 | 76.70 | 80.23 |
| 13 | 66.66 | 86.88 | 74.41 | 80.33 |
| 15 | 64.08 | 87.09 | 70.93 | 80.50 |
| 17 | 70.23 | 86.71 | 72.99 | 81.46 |
| 19 | 70.94 | 85.31 | 74.59 | 83.75 |
| 3 | 63.05 | 87.53 | 72.48 | 83.83 |
| 4 | 63.05 | 92.20 | 72.48 | 84.11 |
| 7 | 63.05 | 85.55 | 72.48 | 80.90 |
| 8 | 63.05 | 81.83 | 72.48 | 78.83 |
| 20 | 63.05 | 74.00 | 72.48 | 72.74 |
| 21 | 63.05 | 78.98 | 72.48 | 73.85 |
| 22 | 63.05 | 81.60 | 72.48 | 73.75 |
| 23 | 63.05 | 84.31 | 72.48 | 73.74 |
| 27 | 63.05 | 79.33 | 72.48 | 75.81 |
| 26 | 63.05 | 78.70 | 72.48 | 75.84 |
| 25 | 63.05 | 77.58 | 72.48 | 76.01 |
| 24 | 63.05 | 75.60 | 72.48 | 75.85 |
| 9 | 71.40 | 90.38 | 75.42 | 82.10 |

Contact angles were measured on bare silicon wafers using a soft bake of 100° C. for 60 sec. EXAMPLE 29

### (For Leaching Test)

Material films were prepared by spin coating the materials onto 8″ bare silicon wafers using TEL ACT12 Clean Track (Tokyo Electron Limited, Japan).

The leaching of the components of a photoresist out of the photoresist film was measured by placing a Teflon O-ring that has a diameter of 5.05 cm above the resist film. 8 ml of DI water was then dispensed into the O-ring. After soaking of 60 s, 2 ml of the water were collected. PAG anion concentration in ng/ml of water sample was measured using Liquid Chromatography/Mass Spectroscopy/Mass Spectroscopy, LC/MS/MS, technique.

Additional examples are provided for leaching experiment studies and are detailed below and the results are given in Table 2.

### PHOTORESIST EXAMPLE 29A

Idential experiments to example 3 were done except that the additive TFTFHMH was 0.0032 g, that was 70 mole % protected with methoxymethyl group and was mixed with 20 g of photoresist from Comparative Example 1. The resultant mixture was placed on a roller for 8h and filtered using 0.2 um filter The coated wafer was then subjected to the above-mentioned leaching test,

### PHOTORESIST EXAMPLE 29B

Idential experiments to example 3 were done except that the additive TFTFHMH was 0.0062 g, that was 70 mole % protected with methoxymethyl group and was mixed with 10 g of photoresist from Comparative Example 1. The resultant mixture was placed on a roller for 8 h and filtered using 0.2 um filter. The coated wafer was then subjected to the above-mentioned leaching test.

### PHOTORESIST EXAMPLE 29C

Idential experiments to example 3 were done except that the additive TFTFHMH was 0.0016 g, that was 70 mole % protected with methoxymethyl group and was mixed with 15 g of photoresist from Comparative Example 1. The resultant mixture was placed on a roller for 8 h and filtered using 0.2 um filter. The coated wafer was then subjected to the above-mentioned leaching test.

### PHOTORESIST EXAMPLE 29D

Idential experiments to example 3 were done except that the additive TFTFHMH was 0.0095 g, that was 100 mole % protected with methoxymethyl group and was mixed with 30 g of photoresist from Comparative Example 1. The resultant mixture was placed on a roller for 8 h and filtered using 0.2 um filter. The coated wafer was then subjected to the above-mentioned leaching test.

### PHOTORESIST EXAMPLE 29E

Idential experiments to example 3 were done except that the additive TFTFHMH was 0.0019 g, that was 100 mole % protected with methoxymethyl group and was mixed with 15 g of photoresist from Comparative Example 1. The resultant mixture was placed on a roller for 8 h and filtered using 0.2 um filter. The coated wafer was then subjected to the above-mentioned leaching test.

### PHOTORESIST EXAMPLE 29F

Idential experiments to example 3 were done except that the additive TFTFHMH was 0.0062 g, that was completely unprotected and was mixed with 15 g of photoresist from Comparative Example 1. The resultant mixture was placed on a roller for 8 h and filtered using 0.2 um filter. The coated wafer was then subjected to the above-mentioned leaching test.

### PHOTORESIST EXAMPLE 29G

Idential experiments to example 3 were done except that the additive TFTFHMH was 0.0312 g, that was completely unprotected and was mixed with 15 g of photoresist from Comparative Example 1. The resultant mixture was placed on a roller for 8Sh and filtered using 0.2 um filter. The coated wafer was then subjected to the above-mentioned leaching test.

TABLE 2
Leaching Data

| | PAG Leaching |
|---|---|
| Example No. | (mol · cm−2 · s−1) |
| 1 | 2.75 × 10⁻¹² |
| 29A | 1.16 × 10⁻¹² |
| 3 | 4.81 × 10⁻¹³ |
| 29B | 2.83 × 10⁻¹³ |
| 29C | 1.26 × 10⁻¹³ |
| 6 | N.D. |
| 29D | 9.36 × 10⁻¹³ |
| 29E | N.D. |
| 29F | 1.44 × 10⁻¹² |
| 29G | 8.18 × 10⁻¹³ |
| water blank reference | N.D. |

ND = Not detected = Response between 0 and 1.0 ng/mL

1. A photoresist composition comprising;
(i) a polymer A comprising at least one acid labile group;
(ii) at least one photoacid generator;
(iii) at least one base;
(iv) a polymer B, where polymer B is non-miscible with polymer A and soluble in the coating solvent, and,
(v) a coating solvent composition.

2. The composition of claim 1, where polymer B comprises a unit of structure 1, 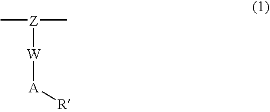
where Z is the polymer backbone, W is a single bond or a spacer group, A is an acid: group without a proton and R′ is hydrogen or an acid labile group.

2. The composition of claim 2, where A can be selected from oxygen (O), sulfur (S), carboxyl (C(O)O), sulfonyl (SO₃) and sulfonamidyl (SO₂NH).

3. The composition of claim 2, where A can be selected from oxygen (O) and R′ is an acid labile group.

3. The composition of claim 1, where polymer B comprises a unit of structure 2, 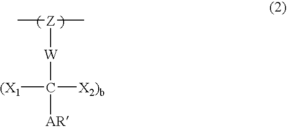
where Z is the polymer backbone, W is a single bond or a spacer group, X₁ and X₂ are partially or fully fluorinated (C₁-C₆) alkyl groups, b=1-6, A is an acidic group without a proton, and R′ is selected independently from hydrogen and an acid labile group.

4. The composition of claim 1, where the polymer B comprises one unit of structure 1 and at least one other unit With an acid labile group.

5. The composition of claim 1, where the polymer B comprises a fluoroalcohol group and is free of acid labile group.

6. The composition of claim 1, where the polymer is a homopolymer of structure 1.

7. The composition of claim 1, where polymer B is selected from a (meth)acrylate polymer, a polymer with an alkylene backbone, a polymer with a partially fluorinated alkylene backbone and a polymer with a fully fluorinated alkylene backbone.

8. The composition of claim 1, where the polymer B is (meth)acrylate polymer, and further where the polymer B comprises a fluoroalcohol group, (CX₁X₂)_{b}—C(O)—OR′, where X₁ and X₂ are fluorine or hydrogen, R′ is hydrogen or an acid labile group, and b=1-6.

9. The composition of claim 1, where the polymer B is derived from a (meth)acrylate monomer comprising a capped fluoroalcohol group, where the capped fluoroalcohol group is (CX₁X₂)_{b}—C(O)—OR₁, where X₁ and X₂ are independently fluorine, hydrogen, and R₁ is an acid labile group and b=1-6.

10. The composition of claim 1, where the polymer B is derived from a polymer with an alkylene or partially fluorinated alkylene backbone, and further comprising a fluoroalcohol group, (CX₁X₂)_{b}—C—OR′, where X₁ and X₂ are fluorine or hydrogen, R′ is hydrogen or an acid labile group and b=1-6.

11. The composition of claim 7, where alkylene is selected from a linear, branched, and cycloaliphatic alkylene and mixtures thereof.

12. The composition of claim 1, where the polymer B is a copolymer.

13. The composition of claim 1, where polymer A is a (meth)acrylate polymer.

14. The composition of claim 1, where polymer A is (meth)acrylate polymer comprising at least one lactone group and at least one substituted or unsubstituted cycloalphatic group.

15. The composition of claim 1, where the photoacid generator comprises at least one sulfonium salt and at least one iodonium salt.

16. The composition of claim 1, where the base is selected from an amine, substituted aniline, and mixtures thereof.

17. The composition of claim 1, where leaching of the photoacid: generator out of the composition is less than or equal to 1.6×10⁻¹².

18. The composition of claim 1, where the water contact angie of the composition is greater than 70°.

19. The composition of claim 1, where the contact angle of the composition in developer is greater than 70°.

20. A process of imaging a photoresist composition comprising,
(i) forming a coating of the photo resist composition of claim 1;
(ii) imagewise exposing the photoresist composition using immersion lithography;
(iii) baking the coating; and,
(iv) developing the exposed photoresist coating with an aqueous alkaline developer.

21. The process of claim 18, where the imagewise exposure is at a wavelength less than 200 nm.

22. The process of claim 18, where the photoresist film has a contact angle in water is greater than 70°

23. The process of claim 18, where the photoresist film has a contact angle in an aqueous alkaline developer is greater than 70°
